(19) United States
(12) Patent Application Publication
(10) Pub. No.: US 2015/0230447 A1
(43) Pub. Date: Aug. 20, 2015

(54) FISHING ROD HOLDER WITH INTEGRAL BITE DETECTOR

(71) Applicant: Alejandro Gabriel Keossian, Granada Hills, CA (US)

(72) Inventor: Alejandro Gabriel Keossian, Granada Hills, CA (US)

(21) Appl. No.: 14/338,184

(22) Filed: Jul. 22, 2014

Related U.S. Application Data
(60) Provisional application No. 61/941,493, filed on Feb. 19, 2014.

(51) Int. Cl. A01K 97/12; A01K 97/00; A01K 97/10

(52) U.S. Cl. CPC A01K 97/125; A01K 97/10; A01K 97/00

(57) ABSTRACT

A system and a fishing-rod-holder with integral fish-bite-detector are disclosed. The fishing-rod-holder may comprise: a substantially hollow-elongate-member, the fish-bite-detector, and a substrate-engagement-means. The hollow-elongate-member may comprise a receiving-cavity. The receiving-cavity may be configured to removably hold a fishing-rod-handle. The fish-bite-detector may comprise a triggering-means, a bite-indication-means, and a circuit. The triggering-means and the bite-indication-means may be in communication with each other via the circuit. The substrate-engagement-means may be attached to the hollow-elongate-member. The substrate-engagement-means may be configured to removably engage a substrate such that the fishing-rod-holder may be removably mounted to the substrate. When the substrate-engagement-means may be removably engaging the substrate and the fishing-rod-handle may be removably inserted and removably held within the receiving-cavity, a fish biting on a baited hook may trigger the triggering-means, wherein the triggering-means may activate the circuit, which may activate the bite-indication-means, wherein an angler may be alerted to the fish bite.

### PRIORITY NOTICE

The present application claims priority under 35 U.S.C. §119(e) to U.S. Provisional Patent Application Ser. No. 61/941,493 filed on Feb. 19, 2014, the disclosure of which is incorporated herein by reference in its entirety.

### STATEMENT REGARDING FEDERAL SPONSORSHIP

No part of this invention was a result of any federally sponsored research.

### TECHNICAL FIELD OF THE INVENTION

The present invention relates to fishing rod holders with integral electronic fish bite detectors and notifiers (alerters) and wherein such fishing rod holders may also comprise a plurality of different substrate engagement means, such as stakes, clamps, slide track (slide rails), and the like.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

When used properly a fish bite detector, that actually works, may provide an angler with a benefit of freeing the angler's time from having to constantly hold a fishing rod while fishing in order to detect fish bites (strikes). Most fish bite detectors may be removably attached to various fishing reel and rod systems. However, most of these fish bite detectors do not combine a fishing rod holder with the fish bite detector, which is undesirable. For example, various bells may be clipped onto a tip of the fishing rod, that may jiggle when the fish bites a hook deployed in a body of water. However, such a bell by itself does not free the angler's time, because the angler also needs to have something hold the fishing rod.

It is desirable for a fish bite detector to be combined and/or integrated with a fishing rod holder because when an angler may be using a fish bite detector, the angler may generally be doing so, so the angler need not have to physically hold the fishing rod while fishing and thus when using a fish bite detector, generally some sort of fishing rod holder must also be used in order for the angler to realize the full benefit of using the fish bite detector.

However, the existing fishing rod holders that may be combined and/or integrated with various fish bite detectors may all suffer from various problems which this present invention seeks to remedy.

For example, in two earlier U.S. patents, the patents may teach a rod holder that may be combined with a bite detector. However, the signaling means in each appears to be limited to only audible signaling means such as buzzers or horns. No visual signaling means is taught. There is no indication of a light source signaling means. Additionally, both these patents only teach a fixed stake means for engaging a substrate, such as an earthen material. The patents do not teach a foldable stake, nor other substrate engagement means such that the device might be used on rails from a boat, pier, or barge. The older of the two, also does not teach any means whereby a foot or hammer may be used to help drive the stake into the substrate. It would be desirable if the device could be used in a multitude of different substrates, such as earthen materials, tubular members, slide tracks (slide rails), and the like.

Additionally, both patents teach a triggering means wherein the rod holder (socket member) pivots at a bottom (or near the bottom) of the rod holder, such that the rod holder might push against a button located outside of the rod holder and towards the top to activate the buzzer/horn. It would be desirable, if the triggering means were streamlined and integrated within the rod holder so as to minimize bulk and complexity, rather than having the triggering means and the indication means located outside of the rod holder.

Additionally, because each triggering means depends upon some pivoting motion of the rod holder itself, there may be a limited range of operational angles between the substrate and the rod holder wherein the device might work properly. It would be desirable if there might be a greater operational angle range that was not limited by a pivoting rod holder.

Further, each patent teaches use of set screws to make adjustments, which may add undesirable steps and complexity to utilize the devices. It would be desirable if use of additional adjustments were eliminated or minimized to reduce undesirable complexity.

Another U.S. patent, less old than the above two, teaches a rod holder combined with a bite detector, wherein the signaling means is an independent flashlight (similar to a Maglite®) that might be removably attached to the rod holder device. Because the signaling means is an independent and somewhat large and bulky flashlight, it would desirable if instead the rod holder used a streamlined and integrated signaling means that was not bulking and cumbersome and that not only permitted visual signaling but also permitted audible signaling. Additionally, the patent only teaches a fixed stake means for engaging the substrate, such as an earthen material. The patent also does not teach any means whereby a foot or hammer may help drive the stake into the substrate. The patent does not teach a foldable stake, nor other substrate engagement means such that the device might be used on rails from a boat, pier, or barge. Additionally, the patent teaches a triggering means wherein the rod holder (socket member) pivots at a middle of the rod holder, such that the rod holder might push against a button located outside of the rod holder and to the bottom to the flashlight. It would be desirable, if the triggering means were streamlined and integrated within the rod holder so as to minimize bulk and complexity, rather than having the triggering means and the indication means located outside of the rod holder.

In another older U.S. patent, but less old that the immediate discussed patent, the patent teaches a rod holder combined with a bite detector, wherein the bite detector, an electrical buzzer or light is mounted on an underside and outside of the rod holder. It would be desirable if instead the bite indicator where integrated within the body of the rod holder to minimize bulkiness. The patent also teaches an anchor line to apparently help keep the fishing rod from slipping out of the rod holder. Additionally, the patent only teaches a fixed stake means (an anchor spear) for engaging the substrate, such as an earthen material. The patent does not teach a foldable stake, nor other substrate engagement means such that the device might be useable on rails from a boat, pier, or barge.

In another older U.S. patent, but less old that the immediate discussed patent, the patent teaches a rod holder combined with a bite detector, wherein the triggering means includes a ratcheting system, i.e. a toothed wheel, wherein as a fish bites the toothed wheel may rotate so a bawl may occupy a different tooth, thus allowing the angler to determine bites by looking at how many teeth have been advanced along the rotating toothed wheel. Additionally, the entire rod may transition from a near vertical position to a near horizontal position during a fish bite. Such an invention does not solve the problem of notifying the angler of fish bites during nighttime fishing activities. Additionally, such a ratcheting system may create undesirable excessive moving parts and complexity, wherein it would be desirable to solve fish bite indication problems by using a simpler device and one that may work at night. Additionally, the patent only teaches a fixed stake means for engaging the substrate, such as an earthen material. The patent does not teach a foldable stake, nor other substrate engagement means such that the device might be useable on rails from a boat, pier, or barge.

In another U.S. patent, but less old that the immediate discussed patent, the patent teaches a rod holder combined with a bite detector, wherein the triggering means utilizes a tether that is clipped onto the rod, wherein during a fish bite the slight bend of the rod may create tension on the tether and activate an alarm. It would be desirable if the triggering means did not rely upon an additional step of having to attach a tether to the fishing rod, instead it would be desirable if once the fishing rod was inserted into the rod holder, no additional steps need be taken. Additionally, the patent only teaches a fixed stake (elongate support) means for engaging the substrate, such as an earthen material. The patent does not teach a foldable stake, nor other substrate engagement means such that the device might be useable on rails from a boat, pier, or barge.

In another U.S. patent, but less old that the immediate discussed patent, the patent teaches a rod holder combined with a bite detector, wherein the triggering means operates by a fish bite causing the rod to shift downwards slightly causing a support wire to pivot out of place by gravity, wherein the rod holder (cradle) may then pivot downwards and strike a button, causing an audible alarm. It would be desirable if the indication means included a visual indication means that might be visible at night. The triggering means then relies upon the entire rod holder pivoting downwards to strike or push against a button. Thus the indicator is located outside of the rod holder. It would be desirable if the indicator, triggering means, and rod holder were all integrated to minimize complexity and bulkiness. And movement of the support wire out of the way relies upon gravity and upon the support wire being sufficient free to pivot downwards. It would be desirable if the triggering means did not rely upon gravity. The patent does not teach a foldable stake, nor any means whereby a foot or hammer might be used to assist pushing the stake into the substrate.

There is a need in the art for a fishing rod holder which includes an integrated fish bite detector, wherein the bite notification may include both an audible notification and a visual notification that might be visible at night. There is a need in the art for a fishing rod holder with integral fish bite detector that might include different substrate engagement means capable of engaging earthen materials, tubular members, slide tracks (slide rails), and the like. There is a need in the art for a fishing rod holder with integral fish bite detector that might include a substrate engagement means that might be foldable and might provide a surface explicitly usable by a foot or hammer to assist pushing a stake into the earthen material.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a fishing-rod-holder with integral fish-bite-detector. Additionally, a system for removably holding a fishing-rod, detecting one or more fish bites, and alerting an angler of such fish bites, without the angler having to hold the fishing-rod while fishing may also be described. The fishing-rod-holder may comprise: a substantially hollow-elongate-member, the fish-bite-detector, and a substrate-engagement-means.

The hollow-elongate-member may comprise an inside-diameter running substantially along an elongate-portion. The inside-diameter and the elongate-portion may be substantially perpendicular to each other. The inside-diameter may be greater than an outside-diameter of a fishing-rod-handle of the fishing-rod, wherein the inside-diameter and the elongate-portion may bound a receiving-cavity. The receiving-cavity may be configured to removably hold the fishing-rod-handle.

The fish-bite-detector may comprise a triggering-means, a bite-indication-means, and a circuit. The triggering-means and the bite-indication-means may be in communication with each other via the circuit.

The substrate-engagement-means may be attached to the hollow-elongate-member. The substrate-engagement-means may be configured to removably engage a substrate such that the fishing-rod-holder may be removably mounted to the substrate. The substrate may be earthen materials, a tubular-member, and/or a slide-track (outer-slide). In various exemplary embodiments, the substrate-engagement-means may be a stake, a foldable stake, various clamps, an inner-slide that may be complimentary with the outer-slide of the slide-track, and the like.

When the substrate-engagement-means may be removably engaging the substrate and the fishing-rod-handle may be removably inserted and removably held within the receiving-cavity, a fish biting (striking) on an article (e.g. a baited hook) in communication with the fishing-rod may trigger the triggering-means, wherein the triggering-means may activate the circuit, wherein the circuit may then activate the bite-indication-means, wherein an angler may be alerted to the fish bite by the energized and activated bite-indication-means.

It is an objective of the present invention to provide a fishing-rod-holder that may not only be combined with a fish-bite-detector, but may also be integral.

It is another objective of the present invention to provide a fishing-rod-holder with integral fish-bite-detector wherein a bite-indication-means may comprise a plurality of signaling means (i.e. alerting means, notification means), including, but not limited to, a light-source and/or a sound-emitting-source.

It is another objective of the present invention to provide a fishing-rod-holder with integral fish-bite-detector wherein the fishing-rod-holder with integral fish-bite-detector may comprise a plurality of different substrate-engagement-means, wherein the different substrate-engagement-means may be used to removably engage earthen materials, tubular-members, slide-tracks (slide-rails), and the like.

It is another objective of the present invention to provide a fishing-rod-holder with integral fish-bite-detector wherein the fishing-rod-holder with integral fish-bite-detector may comprise a foldable stake substrate-engagement-means, wherein the foldable stake may further comprise a platform to be removably engaged by a foot of the angler or a hammer to assist in driving the foldable stake into the earthen material.

It is another objective of the present invention to provide a fishing-rod-holder with integral fish-bite-detector wherein a number of moving parts, particularly moving part external to the fishing-rod-holder may be minimized; and whereby bulkiness and complex external geometry to the fishing-rod-holder may be minimized.

It is yet another objective of the present invention to provide a fishing-rod-holder with integral fish-bite-detector wherein simplicity of use may be maximized so additional setup and adjustment steps may be not be necessary, i.e. the main steps may be removably securing the substrate-engagement-means to the substrate, deploying the baited hook into a body of water and removably placing the fishing-rod into the fishing-rod-holder.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) may depict an exemplary embodiment of a fishing-rod-holder, wherein the fishing-rod-holder may be removably holding a fishing-rod-handle and wherein a substrate-engagement-means of the fishing-rod-holder may be removably inserted into a soil/sand substrate, all shown from a side perspective view. In this depiction, a fish-bite-detector may not be triggered.

FIG. 1(b) may depict the exemplary embodiment of FIG. 1(a), except now a fish may be biting an article and triggering the fish-bite-detector, all shown from a side perspective view.

FIG. 1(c) may depict a close-up partial cut-away of FIG. 1(a), wherein the close-up may focus on a region around the fish-bite-detector, showing pressure-plate-contacts may not be in physical communication with circuit-contacts.

FIG. 1(d) may depict a close-up partial cut-away of FIG. 1(b), wherein the close-up may focus on a region around the fish-bite-detector, showing pressure-plate-contacts may be in physical communication with circuit-contacts.

FIG. 2(a) may depict an exemplary embodiment of a fishing-rod-holder, shown from a perspective view.

FIG. 2(b) may depict the exemplary embodiment of FIG. 2(a), shown from a front view (also known as a light source view).

FIG. 2(c) may depict the exemplary embodiment of FIG. 2(a), shown from a back view (also known as a receiving cavity view). FIG. 2(c) may be rotated longitudinally about 180 degrees from FIG. 2(b).

FIG. 2(d) may depict the exemplary embodiment of FIG. 2(a), shown from a right (or left) view. FIG. 2(d) may be rotated longitudinally about 90 degrees from FIG. 2(b) (or from FIG. 2(c)).

FIG. 2(e) may depict the exemplary embodiment of FIG. 2(a), shown from a top view.

FIG. 2(f) may depict the exemplary embodiment of FIG. 2(a), shown from a bottom view.

FIG. 3(a) may depict an exemplary embodiment of the fishing-rod-holder, wherein a stake may be in the process of being folded (or unfolded), shown from a side view (right or left view).

FIG. 3(b) may depict the exemplary embodiment of FIG. 3(a), wherein the stake may be removably folded into the receiving-cavity, for convenient storage, shown from a side view (right or left view).

FIG. 3(c) may depict the exemplary embodiment of FIG. 3(b), shown from a perspective view, wherein the view may have rotated longitudinally from FIG. 3(b).

FIG. 3(d) may depict the exemplary embodiment of FIG. 3(c), shown from a perspective view, wherein the view may have been rotated about 180 degrees from FIG. 3(c).

FIG. 4(a) may depict an exemplary embodiment of the fishing-rod-holder, shown from an exploded perspective front view.

FIG. 4(b) may depict an exemplary embodiment of hollow-elongate-member, shown from an exploded perspective back view.

FIG. 5(a) may depict a cutaway of a housing depicting a compartment, wherein a circuit may be housed within the compartment, shown from a front perspective view.

FIG. 5(b) may depict an exemplary embodiment of a circuit diagram for a circuit of the fishing-rod-holder.

FIG. 6(a) may depict another exemplary embodiment of the fishing-rod-holder, wherein the substrate-engagement-means may comprise a tubing-clamp, shown from a front perspective view.

FIG. 6(b) may depict the exemplary embodiment of FIG. 6(a), but shown from a back perspective view.

FIG. 6(c) may depict another exemplary embodiment of the fishing-rod-holder, wherein the substrate-engagement-means may comprise a removable-clamp, shown from a front perspective view.

FIG. 6(d) may depict the exemplary embodiment of FIG. 6(c), but shown from a back perspective view.

FIG. 6(e) may depict another exemplary embodiment of the fishing-rod-holder, wherein the substrate-engagement-means may comprise an inner-slide, shown from a front perspective view.

FIG. 6(f) may depict the exemplary embodiment of FIG. 6(e), but shown from a back perspective view.

### DETAILED DESCRIPTION OF THE INVENTION

A fishing-rod-holder with integral fish-bite-detector may be disclosed. Additionally, a system for removably holding a fishing-rod, detecting one or more fish bites, and alerting an angler of such fish bites, without the angler having to hold the fishing-rod while fishing may also be disclosed. The fishing-rod-holder may comprise: a substantially hollow-elongate-member, the fish-bite-detector, and a substrate-engagement-means.

The hollow-elongate-member may comprise an inside-diameter running substantially along an elongate-portion. The inside-diameter and the elongate-portion may be substantially perpendicular to each other. The inside-diameter may be greater than an outside-diameter of a fishing-rod-handle of the fishing-rod, wherein the inside-diameter and the elongate-portion may bound a receiving-cavity. The receiving-cavity may be configured to removably hold the fishing-rod-handle.

The fish-bite-detector may comprise a triggering-means, a bite-indication-means, and a circuit. The triggering-means and the bite-indication-means may be in communication with each other via the circuit.

The substrate-engagement-means may be attached to the hollow-elongate-member. The substrate-engagement-means may be configured to removably engage the substrate such that the fishing-rod-holder may be removably mounted to the substrate. The substrate may be earthen materials, a tubular-member, and/or a slide-track (outer-slide). In various exemplary embodiments, the substrate-engagement-means may be a stake, a foldable stake, various clamps, an inner-slide that may be complimentary with the outer-slide of the slide-track, and the like.

When the substrate-engagement-means may be removably engaging the substrate and the fishing-rod-handle may be removably inserted and removably held within the receiving-cavity, a fish biting (striking) on an article (e.g. a baited hook) in communication with the fishing-rod may trigger the triggering-means, wherein the triggering-means may activate the circuit, wherein the circuit may then activate the bite-indication-means, wherein an angler may be alerted to the fish bite by the energized and activated bite-indication-means.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

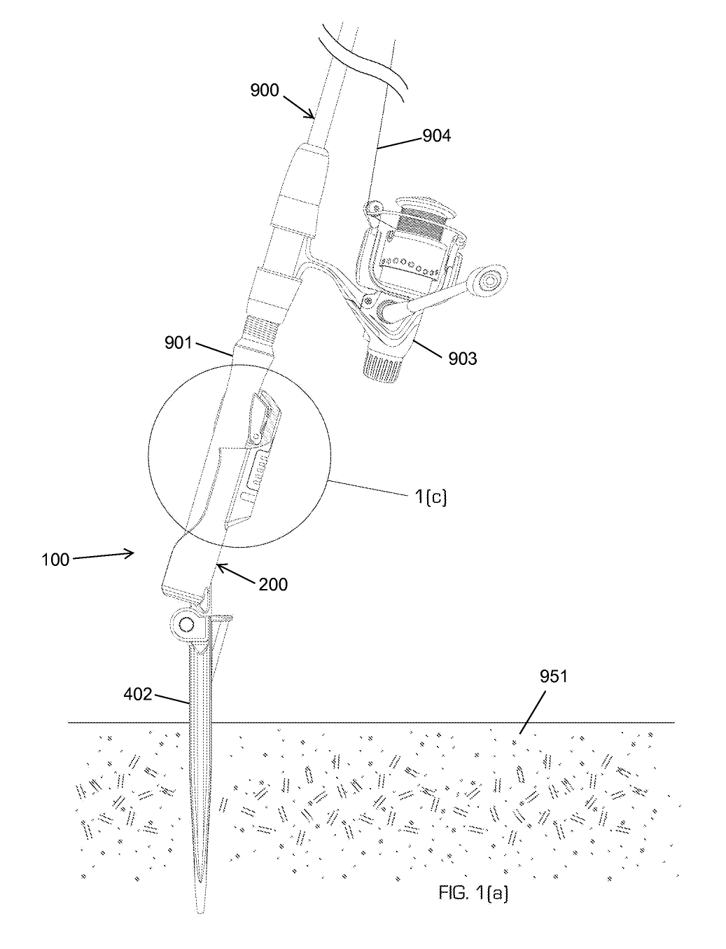

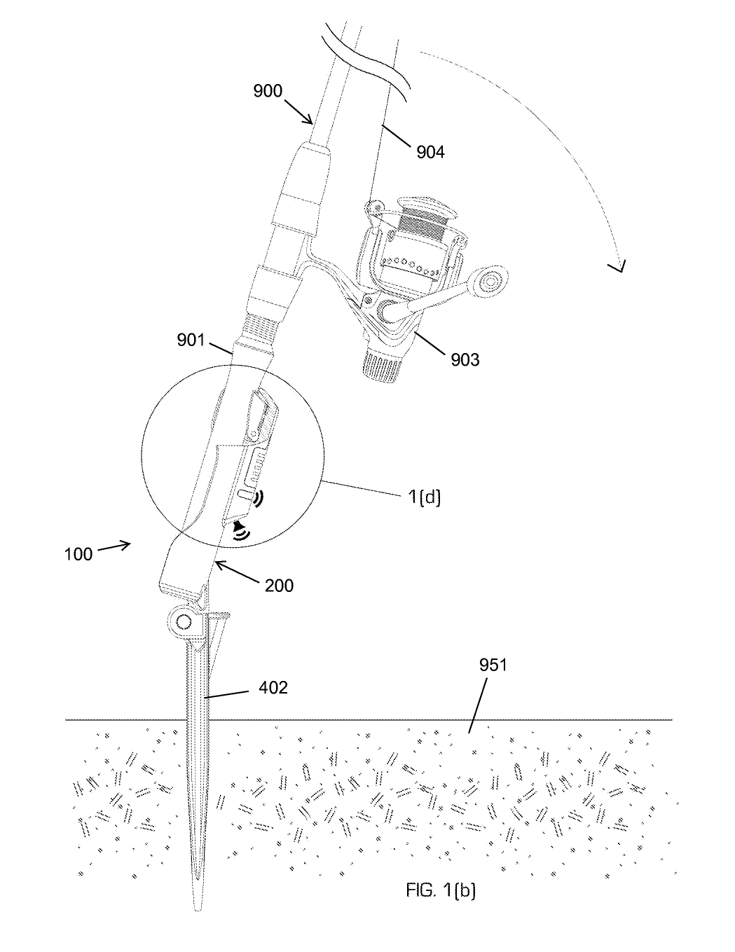

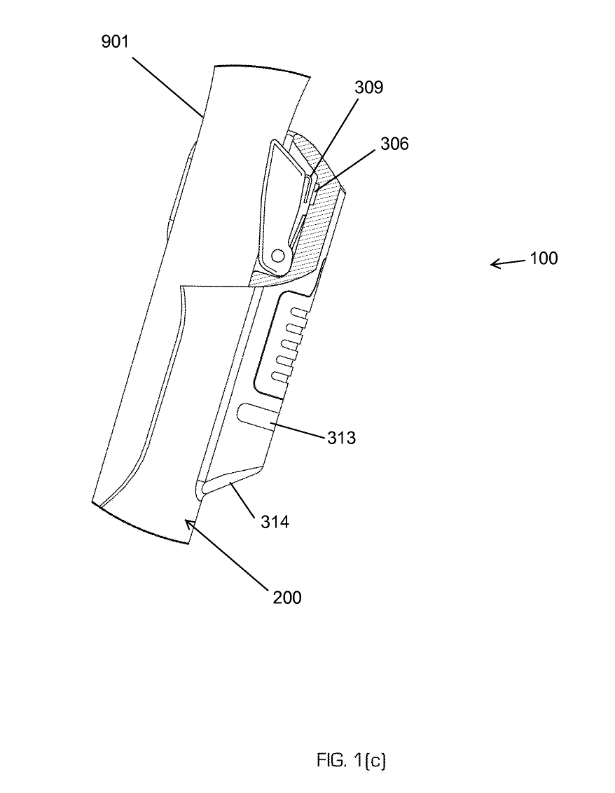

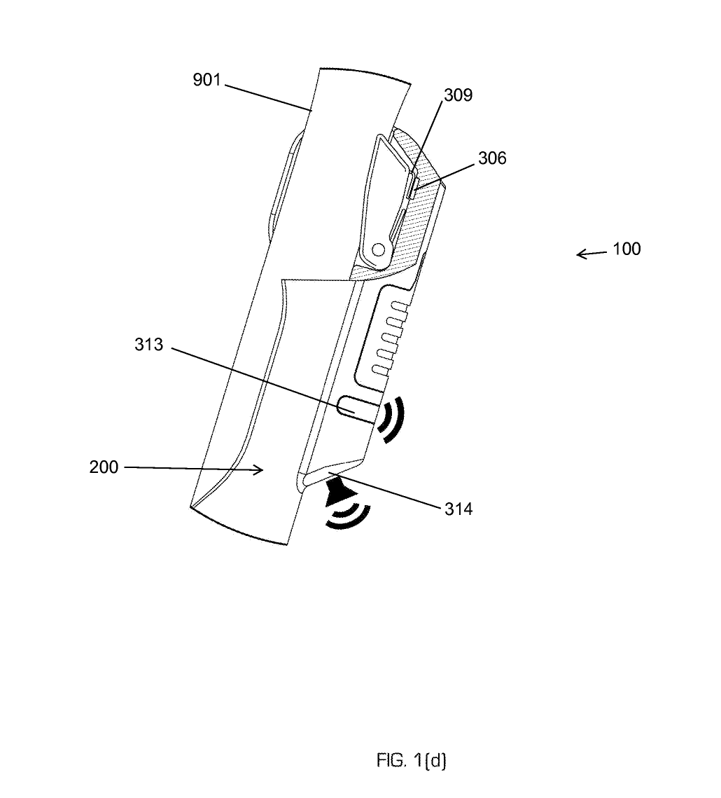

A FIG. 1 series of figures may comprise FIG. 1(a), FIG. 1(b), FIG. 1(c), and FIG. 1(d). FIG. 1(a) may depict an exemplary embodiment of a fishing-rod-holder 100, wherein fishing-rod-holder 100 may be removably holding a fishing-rod-handle 901, wherein a substrate-engagement-means (e.g. a stake 402) of fishing-rod-holder 100 may be removably inserted into a soil and/or sand substrate 951 (i.e. earthen material 951), and wherein all these components may be shown from a side perspective view. In FIG. 1(a), a fish-bite-detector of fishing-rod-holder 100 may not be triggered.

Also shown in FIG. 1(a), may be fishing-rod 900. Fishing-rod 900 may comprise fishing-rod-handle 901, fishing-reel 903, and fishing-line 904. Fishing-rod-handle 901 may be a terminal end of fishing-rod 900, the terminal end of fishing rod 900 that might be held by an angler during fishing or inserted into a substrate or held by a fishing rod holder. Fishing-reel 903 may be removably mounted to the fishing-rod 900. Fishing-reel 903 may be a spinning reel, a conventional reel (including bait caster, free spool, and star drag), a spincast reel (e.g. often used by novice anglers and children), or a fly reel. Fishing-line 904 may removably attach an article to fishing-reel 903. The article may not be depicted in the FIGs. In some embodiments, the article may be a baited fishing hook deployed in a body of water. The baited hook may be attached to a fishing-rod 900 by fishing-line 904.

FIG. 1(b) may depict the exemplary embodiment of FIG. 1(a), except now a fish may be biting the article and triggering the fish-bite-detector, all shown from a side perspective view.

FIG. 1(c) may depict a close-up partial cut-away of FIG. 1(a), wherein the close-up may focus on a region around the fish-bite-detector, showing pressure-plate-contacts 309 may not be in physical communication with circuit-contacts 306, resulting in an open and unactivated circuit 303. Pressure-plate-contacts 309 may be a component of a pressure-plate 307. Pressure-plate 307 may be component of the triggering-means. The triggering-means may be a component of the fish-bite-detector. Circuit-contacts 306 may be a component of circuit 303. Circuit 303 may be a component of the fish-bite-detector.

FIG. 1(d) may depict a close-up partial cut-away of FIG. 1(b), wherein the close-up may focus on a region around the fish-bite-detector, showing pressure-plate-contacts 309 may be in physical communication with circuit-contacts 306, resulting in a closed and activated circuit 303. Activated circuit 303 may energize a bite-indication-means. The energized bite-indication-means may alert the angler of a fish bite.

As a fish bites (strikes) the article (e.g. baited hook), such biting may result in a pulling (tension) stress to fishing-line 904. This pulling stress to fishing-line 904 may in turn result on downward pressure to fishing-rod 900, i.e. fishing-rod 900 being pulled towards the body of water, particular a tip of fishing-rod 900. This downward pressure to fishing-rod 900 may result in fishing-rod-handle 901 exerting pressure onto pressure-plate 307. The exerted pressure onto pressure-plate 307 may result in pressure-plate-contacts 309 physically contacting circuit-contacts 306. This may result in a closed and activated circuit 303.

Note, when fishing-rod 900 may be removable held by fishing-rod-holder 100, pressure-plate 307 may be physical contact with fishing-rod-handle 901, regardless if a fish may be biting or not.

Note, in various embodiments, the bite-indication-means may be triggered while fishing-rod 900, when removably held by fishing-rod-holder 100, may be in a variety of angles with respect to the substrate. For example, and without limiting the scope of the present invention, if the substrate may be a roughly horizontal surface, then a longitude of fishing-rod 900 may be at an angle of 0 degrees to 120 degrees with respect to the substrate, while fishing-rod 900 may be removably held by fishing-rod-holder 100, and the bite-indication-means may still be triggered by the biting fish.

In the exemplary embodiment of fishing-rod-holder 100 depicted in FIG. 1(c) and FIG. 1(d), the bite-indication-means may comprise both a light-source 313 and a sound-emitting-source 314. FIG. 1(d) may depict light-source 313 emitting a light visible to the angler and sound-emitting-source 314 emitting a sound (noise) audible to the angler.

Of course, whether the angler may see the emitted visible light and/or hear the emitted audible sound may depend upon several factors, such as how close the angler may be to fishing-rod-holder 100 when the trigger-means may be triggered, the time of day (or night), weather conditions, any ambient noise (e.g. background environmental noise), the angler's seeing abilities, the angler's hearing abilities, and the like. For example, and without limiting the scope of the present invention, the visible light may be seen by an angler at nighttime in the dark on a clear night from 100 feet or less between the angler and fishing-rod-holder 100, assuming no obstructions in the line of sight. For example, and without limiting the scope of the present invention, the audible sound may be heard by an angler on quiet day or night from 100 feet or less between the angler and fishing-rod-holder 100.

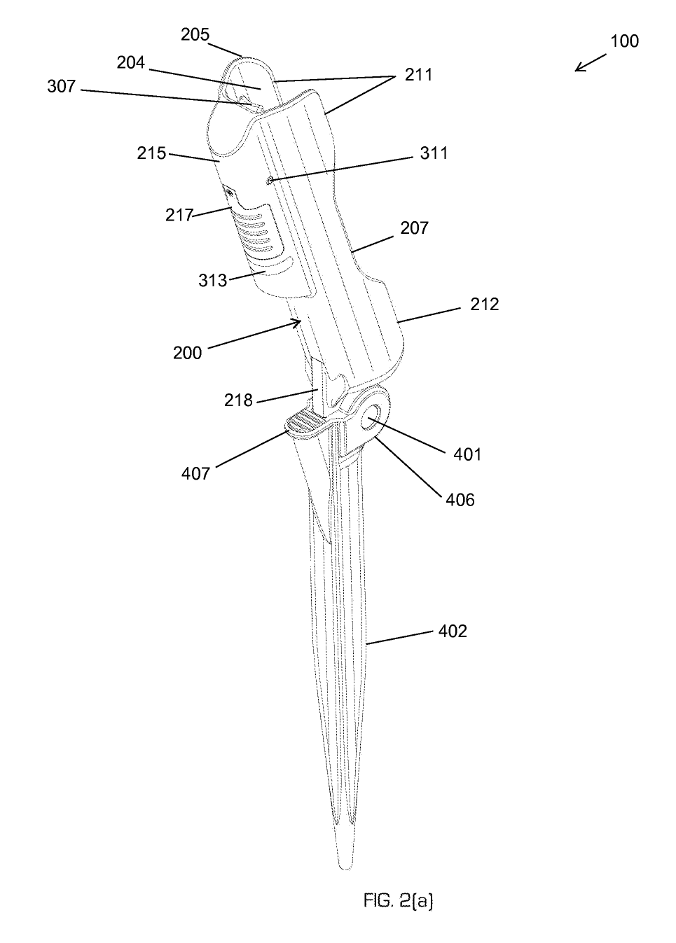

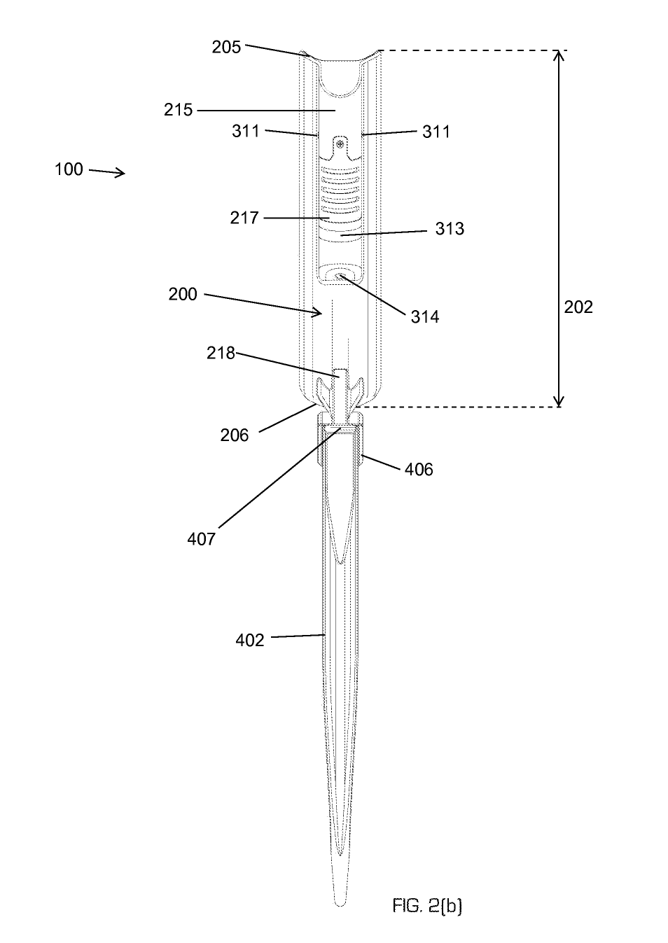

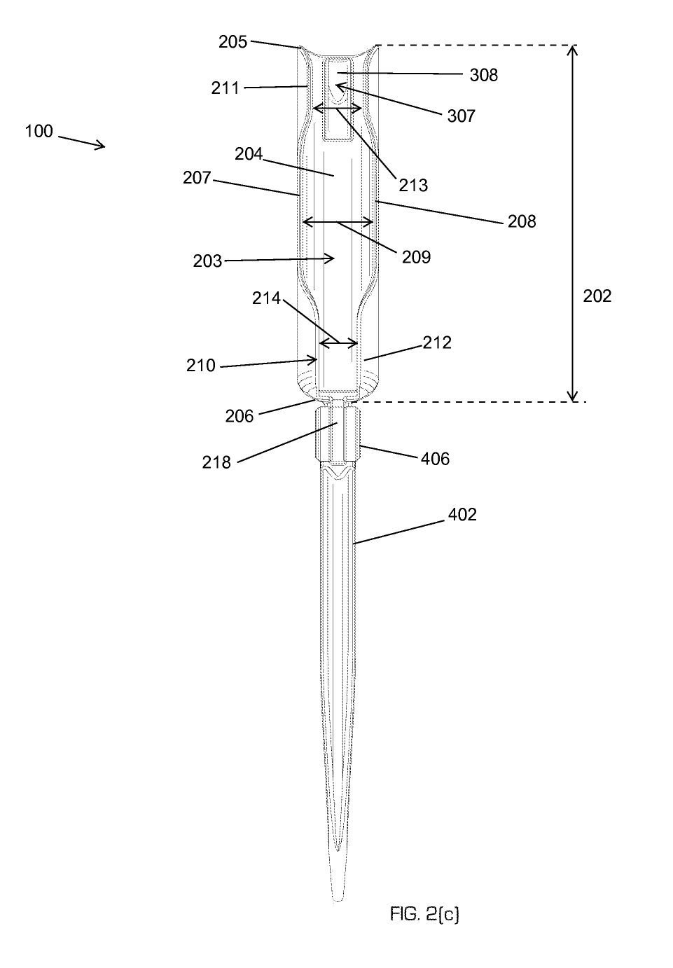

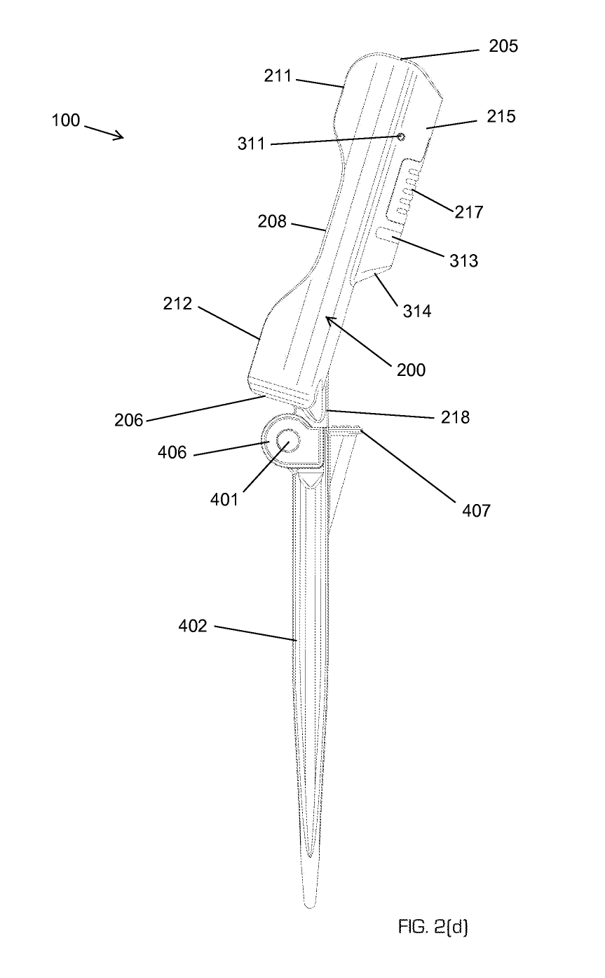

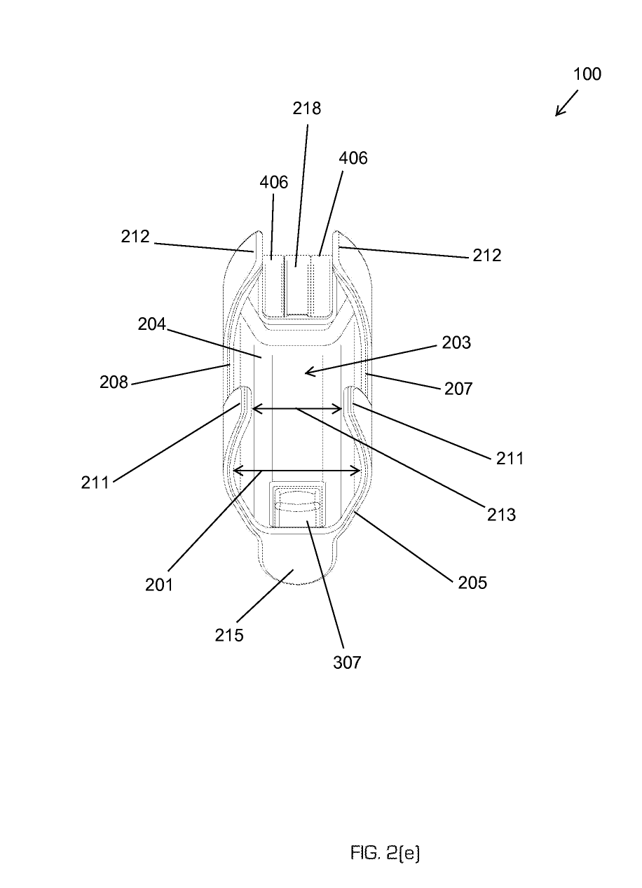

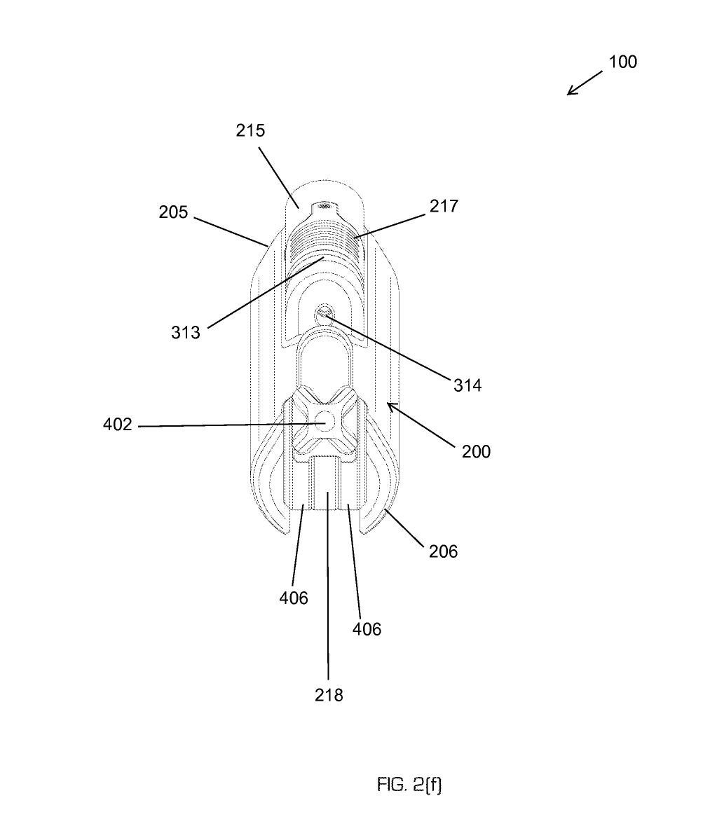

Now turning to a discussion of the FIG. 2 series of figures. The FIG. 2 series of figures may depict a fully assembled fishing-rod-holder 100 from various views and without depicting fishing-rod-handle 901, fishing-rod 900, fishing-reel 903, fishing-line 904, and the article.

FIG. 2(a) may depict an exemplary embodiment of fishing-rod-holder 100, shown from a perspective view. FIG. 2(b) may depict the exemplary embodiment of FIG. 2(a), shown from a front view (also known as a light source view because light-source 313 may be clearly depicted). FIG. 2(c) may depict the exemplary embodiment of FIG. 2(a), shown from a back view (also known as a receiving cavity view because a receiving-cavity 203 may be clearly depicted). FIG. 2(c) may be rotated longitudinally about 180 degrees from FIG. 2(b). That is, FIG. 2(b) and FIG. 2(c) may be opposing views. FIG. 2(d) may depict the exemplary embodiment of FIG. 2(a), shown from a right (or left) view. FIG. 2(d) may be rotated longitudinally about 90 degrees from FIG. 2(b) (or from FIG. 2(c)). FIG. 2(e) may depict the exemplary embodiment of FIG. 2(a), shown from a top view, i.e. from an observer looking down upon an insertion-end 205. FIG. 2(f) may depict the exemplary embodiment of FIG. 2(a), shown from a bottom view, i.e. a view opposing FIG. 2(e).

In some embodiments, fishing-rod-holder 100 may comprise a hollow-elongate-member 200, the fish-bite-detector, and the substrate-engagement-means.

Hollow-elongate-member 200 may be substantially hollow. Hollow-elongate-member 200 may comprise an inside-diameter 201 (see FIG. 2(e)) running substantially along an elongate-portion 202 (see FIG. 2(c) and/or FIG. 2(d)). Elongate-portion 202 may run a longitudinal length of hollow-elongate-member 200. Such a longitudinal length may be sized in comparison to a longitudinal length of fishing-rod-handle 901 to be removably held by fishing-rod-holder 100. Inside-diameter 201 and elongate-portion 202 may be substantially perpendicular to each other. Inside-diameter 201 may be greater than an outside-diameter of fishing-rod-handle 901 of fishing-rod 900. Inside-diameter 201 and elongate-portion 202 may bound receiving-cavity 203. Receiving-cavity 203 may be configured to removably hold fishing-rod-handle 901.

In some embodiments, hollow-elongate-member 200 may comprise an interior-surface 204 (e.g. see FIG. 2(a) and/or FIG. 2(c)) running along inside-diameter 201 and along elongate-portion 202. Interior-surface 204 may face fishing-rod-handle 901 when fishing-rod-handle 901 may be removably held within receiving-cavity 203. In some embodiments, when fishing-rod-handle 901 may be removably held by receiving-cavity 203, regions of interior-surface 204 may be in physical contact with fishing-rod-handle 901.

In some embodiments, hollow-elongate-member 200 may comprise two terminal ends disposed of each other, insertion-end 205 and a butt-end 206. For example, see FIG. 2(a) and/or FIG. 2(b) for insertion-end 205 and butt-end 206. Insertion-end 205 and butt-end 206 may be separated by elongate-portion 202. Insertion-end may be substantially open to permit removable insertion of fishing-rod-handle 901. Butt-end 206 may be configured to prevent fishing-rod-handle 901 from translating beyond butt-end 206 when receiving-cavity 203 may be removably holding fishing-rod-handle 901.

In some embodiments, butt-end 206 may be closed or partially closed in order to prevent fishing-rod-handle 901 from translating beyond butt-end 206. In embodiments wherein butt-end 206 may be partially open, such a geometry may include a benefit of allowing water to drain from receiving-cavity 203. In embodiments wherein butt-end 206 may be partially open, such a geometry may be accomplished by a plurality of perforations in butt-end 206, a crisscross lattice pattern, and the like.

In some embodiments, hollow-elongate-member 200 may comprise an opening-edge. The opening-edge may be a single continuous edge of hollow-elongate-member 200. Along elongate-portion 202, the opening-edge may comprise two opposing opening-edges, a first-edge-portion 207 and a second-edge-portion 208. As depicted in FIG. 2(c), first-edge-portion 207 may be separated from second-edge-portion 208 by an edge-separation-distance 209, such that first-edge-portion 207 and second-edge-portion 208 may bound an elongate-opening 210. Elongate-opening 210 comprises a width of edge-separation-distance 210 and a length of the elongate-portion 202.

In some exemplary embodiments, edge-separation-distance 209 may need to be of a sufficient width to permit passage of a transverse width of stake 402, when stake 402 may be removably folded and stored within receiving-cavity 203.

In exemplary embodiments, edge-separation-distance 209 may be sized in relation to the outside diameter of fishing-rod-handle 901, such that fishing-rod-handle 901 may removably be held within receiving-cavity 203. That is, fishing-rod-holder 100 may be manufactured in different sizes to accommodate different sized fishing-rods 900. Light tackle fishing rods generally include smaller outside diameters of fishing-rod-handle 901 than heavier tackle fishing rods.

For example, and without limiting the scope of the present invention, in some exemplary embodiments edge-separation-distance 209 may be 0.50 inch; while other edge-separation-distance 209 in other embodiments may be 0.75 inch or 1.50 inch, to accommodate the outside diameter of different fishing-rod-handles 901. In any given embodiment, edge-separation-distance 209 may be a substantially fixed dimension, but with some variation due to flexing and/or bending inherent in the materials of construction.

In some embodiments, the opening-edge along the top of hollow-elongate-member 200, may also run substantially along inside-diameter 201 of insertion-end 205.

In some embodiments, hollow-elongate-member 200 may comprise at least one pair-of-wings. Each wing of the pair-of-wings may partially extend from the opening-edge into elongate-opening 210, such that each wing of the pair-of-wings may separated from each other by a wing-separation-distance. The pair-of-wings may be configured to partially circumscribe the outside-diameter of fishing-rod-handle 901 when fishing-rod-handle 901 may be removably held within the receiving-cavity 203, such that the pair-of-wings prevents fishing-rod-handle 901 from slipping out of elongate-opening 210.

As depicted in FIG. 2(c), in some embodiments, the at least one pair-of-wings may comprise a first-pair-of-wings 211 and a second-pair-of-wings 212. First-pair-of-wings 211 may be located closer to insertion-end 205 than to butt-end 206. Second-pair-of-wings 212 may be located closer to butt-end 206 than to insertion-end 205. Each first-wing 211 of first-pair-of-wings 211 may be separated from each other by a first-wing-separation-distance 213. Each second-wing 212 of the second-pair-of-wings 212 may be separated from each other by a second-wing-separation-distance 214. Both first-wing-separation-distance and second-wing-separation-distance 214 may each be less than edge-separation-distance 209. Edge-separation-distance 209 may be greater than first-wing-separation-distance 213. Edge-separation-distance 209 may be greater than second-wing-separation-distance 214.

For example, and without limiting the scope of the present invention, in some exemplary embodiments first-wing-separation-distance 213 may be 0.90 inch; while other first-wing-separation-distance 213 in other embodiments may be from 0.85 inch to 1.25 inch, to accommodate the outside diameter of different fishing-rod-handles 901. In any given embodiment, first-wing-separation-distance 213 may be a substantially fixed dimension, but with some variation due to flexing and/or bending inherent in the materials of construction.

For example, and without limiting the scope of the present invention, in some exemplary embodiments second-wing-separation-distance 214 may be 0.65 inch; while other second-wing-separation-distance 214 in other embodiments may be from 0.60 inch to 1.00 inch, to accommodate the outside diameter of different fishing-rod-handles 901. In any given embodiment, second-wing-separation-distance 214 may be a substantially fixed dimension, but with some variation due to flexing and/or bending inherent in the materials of construction.

In some exemplary embodiments, second-wing-separation-distance 214 may need to be of a sufficient width to permit passage of the transverse width of stake 402, when stake 402 may be removably folded and stored within receiving-cavity 203.

In some embodiments, the substrate-engagement-means may be attached to hollow-elongate-member 200. The substrate-engagement-means may be configured to removably engage the substrate such that fishing-rod-holder 100 may be removably mounted to the substrate.

In some embodiments, the substrate may be an earthen material 951. In some embodiments, earthen materials may be selected from soil, sand, and the like.

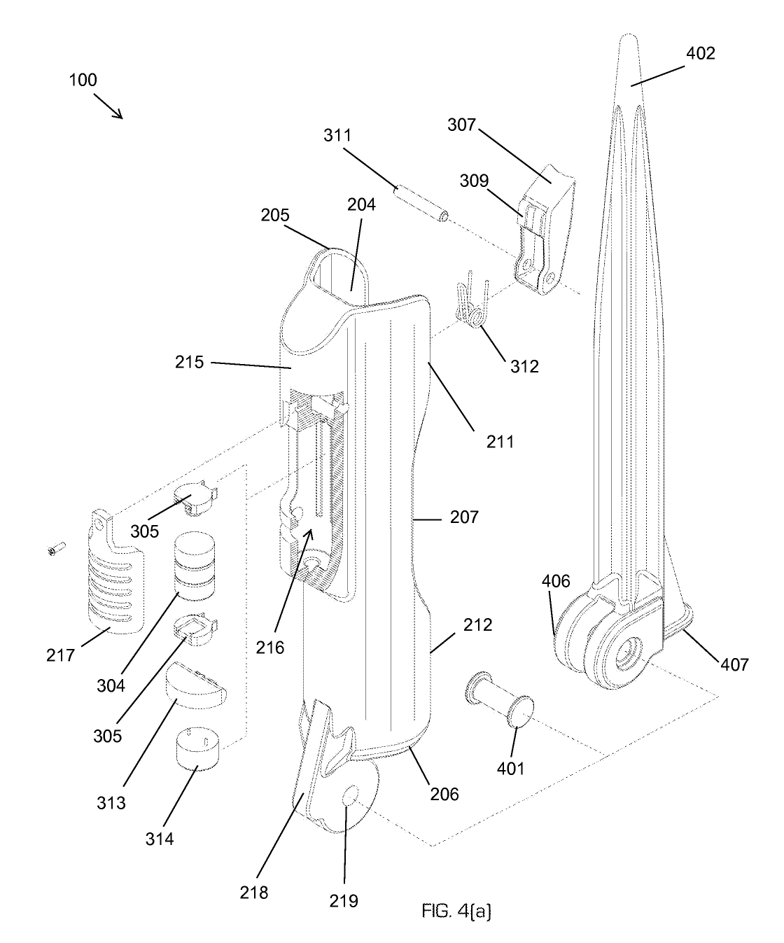

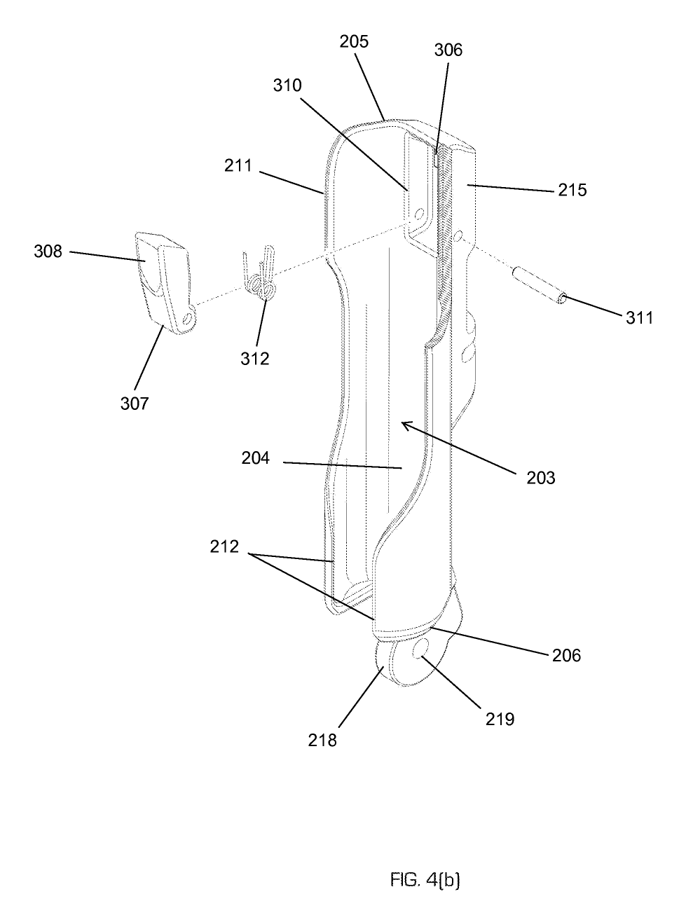

In some embodiments, hollow-elongate-member 200 may comprise an anchor 218 (see e.g. FIG. 2(a)). Anchor 218 may serve as a point of attachment for the substrate-engagement-means to attach to hollow-elongate-member 200. Anchor 218 may comprise a flange, extending substantially longitudinally from and away from butt-end 206. The flange may comprise a hole 219 (see e.g. FIG. 4(a)) passing through a region of the flange. Continuing discussing the FIG. 2 series of figures, hole 219 may be configured to receive a pivot-rod 401 of the substrate-engagement-means. Pivot-rod 401 may pass through hole 219.

In some exemplary embodiments, the substrate-engagement-means may comprise stake 402 and pivot-rod 401. Stake 402 may be a rigid member configured to be removably inserted into earthen material 951. Stake 402 may comprise two terminal ends, with an at least one pivot-rod-receiving-hole located at one of the two terminal ends. The remaining terminal end may be the end which may be driven into earthen material 951.

In some embodiments, stake 402 may further comprise a platform 407 (see e.g. FIG. 2(a)), wherein platform 407 may be configured to be stepped upon by an angler's foot or struck by a hammer, to assist driving stake 402 into earthen material 951. Such a platform 407 may be substantially perpendicular with a longitude of stake 402, wherein such a longitude runs from one terminal end to the other. A top surface of platform 407 may comprise non-slippage raised geometry.

In the exemplary embodiments depicted in the FIGs, the at least one pivot-rod-receiving-hole may comprise two such pivot-rod-receiving-holes. When pivot-rod 401 may pass through both hole 219 and the at least one pivot-rod-receiving-hole, stake 402 may be attached to anchor 218. When pivot-rod 401 may pass through both hole 219 and the at least one pivot-rod-receiving-hole, stake 402 may be foldable with respect to the hollow-elongate-member 200.

In some exemplary embodiments, the inner diameters of hole 219 and the at least one pivot-rod-receiving-hole may be substantially similar. Additionally, an outer diameter of pivot-rod 401 may be substantially similar to the inner-diameters of hole 219 and the at least one pivot-rod-receiving-hole, such there may be friction when pivot-rod 401 may be inserted through hole 219 and the at least one pivot-rod-receiving-hole. Such friction may permit various articulable positions between hollow-elongate-member 200 and the substrate-engagement-means (e.g. stake 402) to be maintained relative to each other even when the fish may be biting (striking) the article.

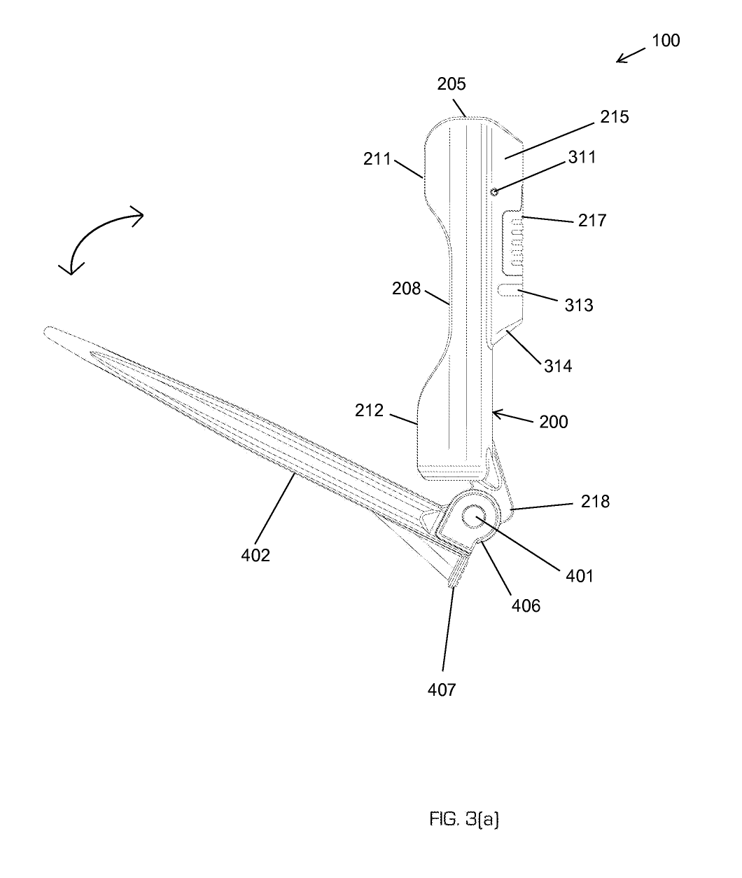

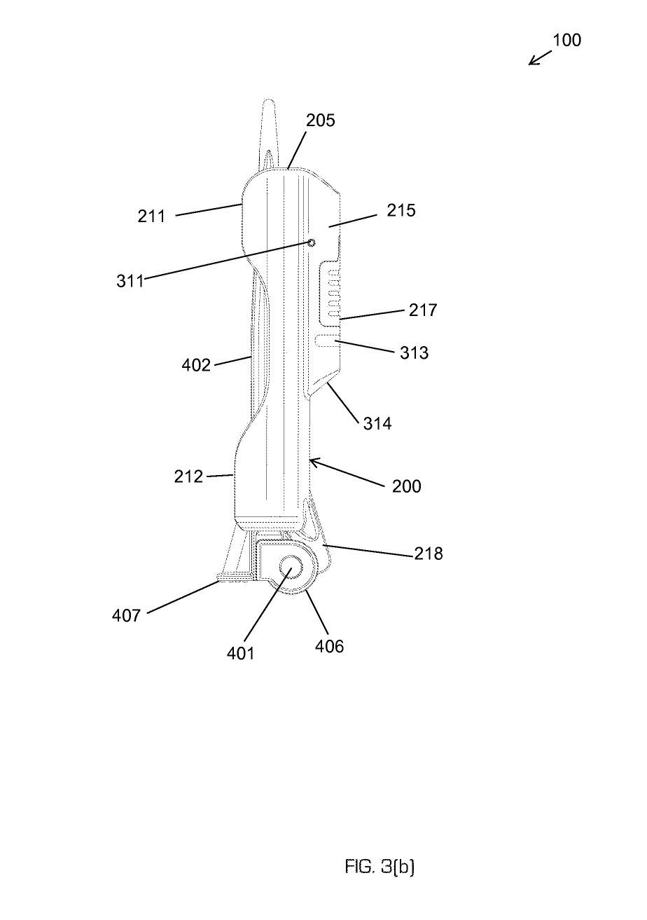

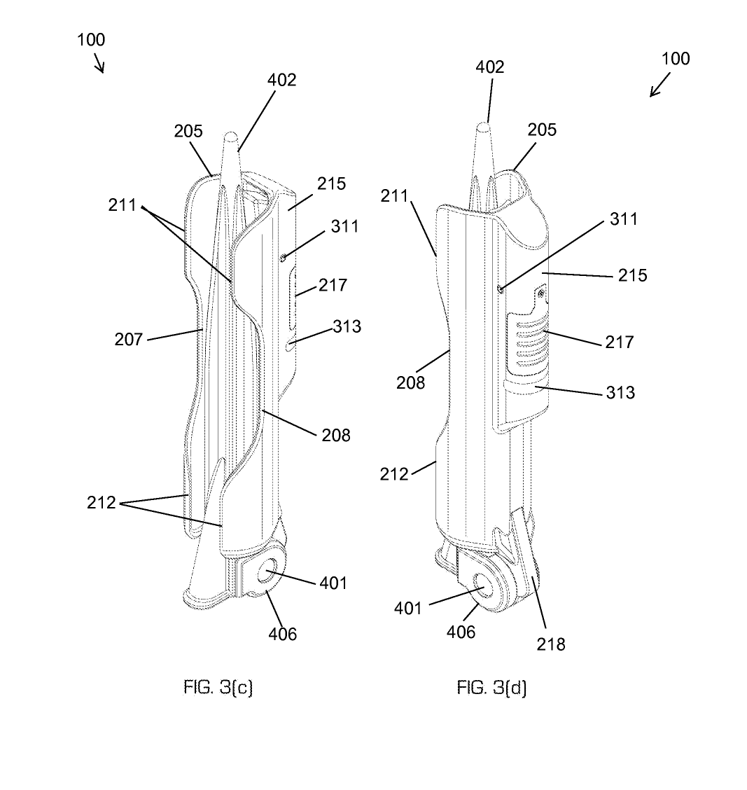

Now turning to the FIG. 3 series of figures. FIG. 3 series of figures may depict the foldable aspect of fishing-rod-holder 100. FIG. 3(a) may depict an exemplary embodiment of the fishing-rod-holder 100, wherein stake 402 may be in the process of being folded (or unfolded), shown from a side view (right or left view). FIG. 3(b) may depict the exemplary embodiment of FIG. 3(a), wherein stake 402 may be removably folded into receiving-cavity 203, for convenient storage, shown from a side view (right or left view). As noted above, in some exemplary embodiments a transverse width of stake 402 may be smaller than second-wing-separation-distance 214, so that stake 402 may be removably folded and stored within receiving-cavity 203. FIG. 3(c) may depict the exemplary embodiment of FIG. 3(b), shown from a perspective view, wherein the view may have rotated longitudinally from FIG. 3(b). FIG. 3(d) may depict the exemplary embodiment of FIG. 3(c), shown from a perspective view, wherein the view may have been rotated about 180 degrees from FIG. 3(c).

Now turning to FIG. 4(a) and FIG. 4(b). FIG. 4(a) may depict an exemplary embodiment of fishing-rod-holder 100, shown from an exploded perspective front view. In some exemplary embodiments, hollow-elongate-member 200 may comprise a housing 215. Housing 215 may be disposed opposite of elongate-opening 210. Housing 215 may be an integral component of hollow-elongate-member 200. Housing 215 may comprise at least one compartment 216. At least one compartment 216 may house the fish-bite-detector. A portion of compartment 216 may be removably sealable by a door 217. Such a portion may be configured to removably hold a power-source 304. Power-source 304 may provide electrical power to the fish-bite-detector.

In some embodiments, when door 217 may be removably sealing the portion of at least one compartment 216, such a sealing may be a waterproof seal, such that a waterproof compartment may result. Such sealing may be accomplished with use of various gasket materials (e.g. elastomers such as rubber, silicone, and the like) running around a periphery of door 217 and/or a periphery of the portion opening.

FIG. 4(b) may depict an exemplary embodiment of hollow-elongate-member 200, shown from an exploded perspective back view (i.e. a view of receiving-cavity 203). Taken together, FIG. 4(a) and FIG. 4(b), depict substantially all of the structure and geometry of hollow-elongate-member 200 and substantially all of the structure and geometry of the fish-bite-detector.

In some exemplary embodiments, the fish-bite-detector may be integral to hollow-elongate-member 200, in that the fish-bite-detector may be substantially housed within housing 215, in at least one compartment 216. In some exemplary embodiments, the fish-bite-detector may comprise the triggering-means, the bite-indication-means, and circuit 303. The triggering-means and the bite-indication-means may be in communication with each other. The triggering-means and the bite-indication-means may be in communication with each other via circuit 303.

In some exemplary embodiments, when the substrate-engagement-means may be removably engaging the substrate (e.g. earthen material 951) and the fishing-rod-handle 901 may be removably inserted and removably held within receiving-cavity 203, the fish biting on the article that may be in communication with fishing-rod 900 may trigger the triggering-means, wherein the triggering-means may activates the bite-indication-means, wherein the angler may be alerted to the fish bite by the bite-indication-means.

In some exemplary embodiments, the fish-bite-detector may comprise circuit 303. Circuit 303 may be substantially located within at least one compartment 216 (see e.g., FIG. 4(a)). Circuit 303 may comprise power-source 304, electrical-connections 305, and circuit-contacts 306. Electrical-connections 305 may connect power-source 304 and circuit-contacts 306, to the bite-indication-means, such that when the triggering-means may be triggered, circuit 303 may be electrically activated and electrical power may flow to the bite-indication-means activating the bite-indication-means.

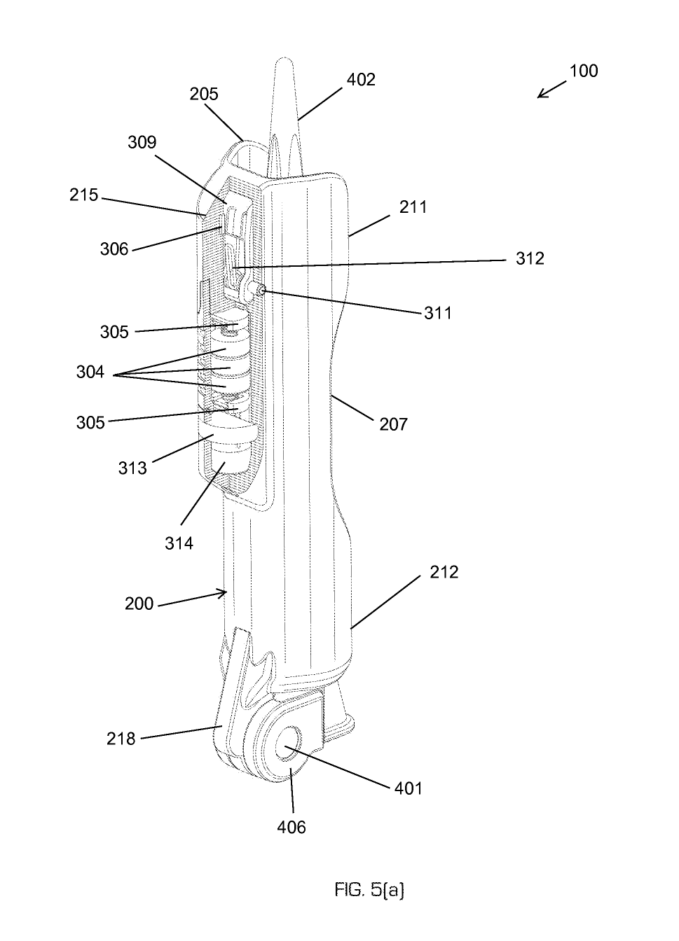

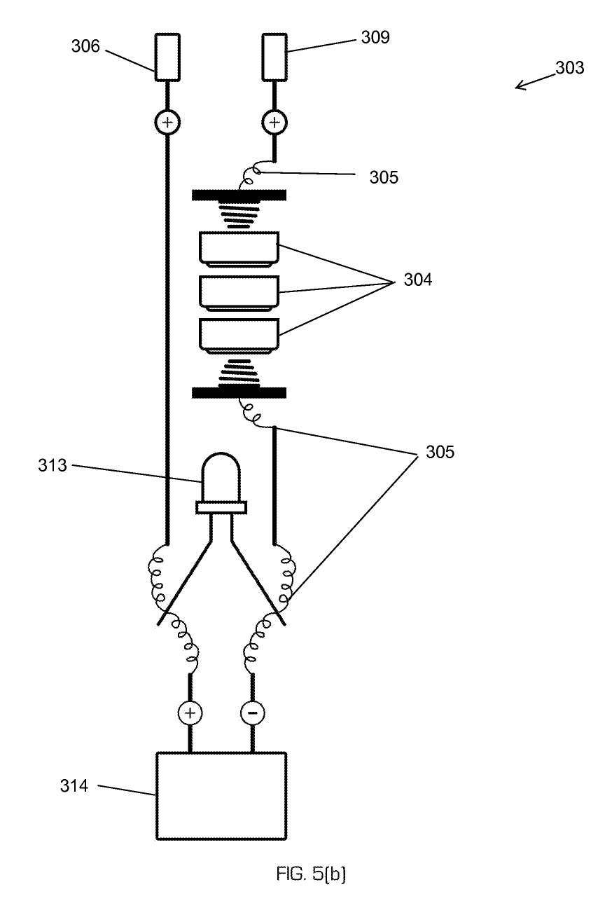

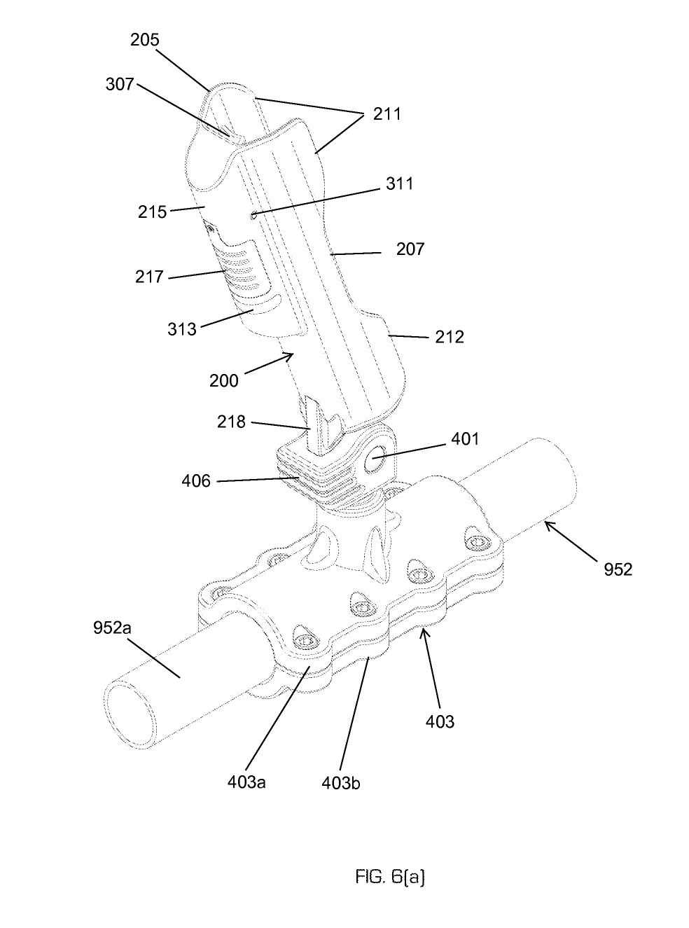

In some exemplary embodiments, power-source 304 may comprise one or more batteries. For example, and without limiting the scope of the present invention, FIG. 4(a) (and FIG. 5(a)) may depict three batteries in serial fashion. In some embodiments, the one or more batteries may be rechargeable. In some exemplary embodiments, such batteries may be button cell batteries, such as AG13/LR44, with a voltage range of 1.5V to 1.55V, approximate dimensions of 11.6 mm diameter by 5.4 mm height, with an alkaline or silver oxide chemistry; or a substantially equivalent battery. In other embodiments, other batteries may be utilized for power-source 304.

In some exemplary embodiments, the triggering-means may comprise: pressure-plate 307 (see FIG. 4(a) and FIG. 4(b)), a pressure-plate-opening 310 (see FIG. 4(b)), a pressure-plate-attachment-means 311 (see FIG. 4(a) and FIG. 4(b)), and a tension-means 312 (see FIG. 4(a) and FIG. 4(b)).

In some embodiments, pressure-plate 307 may comprise a generally rectangular-prism geometry, see e.g. FIG. 4(a). Pressure-plate 307 may comprise a rod-surface 308 (see FIG. 4(b)). Rod-surface 308 may be configured to be in physical communication with fishing-rod-handle 901 when fishing-rod-handle 901 may be removably held within receiving-cavity 203, regardless if the fish may be biting or not. Rod-surface 308 may be a part of pressure-plate 307 that fishing-rod-handle 901 pushes against. Pressure-plate 307 may comprise pressure-plate-contacts 309 (see FIG. 4(a)) disposed opposite of rod-surface 308. When pressure-plate-contacts 309 may come into physical communication (contact) with circuit-contacts 306, circuit 303 may be closed and electrically activated.

In some embodiments, pressure-plate-opening 310 may provide an opening through interior-surface 201 for pressure-plate 307 to partially extend into receiving-cavity 203. Pressure-plate-opening 310 may be disposed opposite elongate-opening 210. In some exemplary embodiments, pressure-plate-opening 310 may be located closer to insertion-end 205 than to butt-end 206.

In some embodiments, pressure-plate-attachment-means 311 may attach one side of pressure-plate 307 to housing 215, such that pressure-plate 307 may pivot about that one side. In some exemplary embodiments, pressure-plate-attachment-means 311 may be disposed opposite pressure-plate-contacts 309 on pressure-plate 307. In some exemplary embodiments, pressure-plate-attachment-means 311 may comprise a pin and hinge system.

In some embodiments, tension-means 312 may push pressure-plate 307 against fishing-rod-handle 901 when fishing-rod-handle 901 may be removably held within receiving-cavity 203, such that pressure-plate-contacts 309 may not activate circuit 303. Tension-means 312 may physically contact pressure-plate 307 at a location pressure-plate 307 disposed between pressure-plate-contacts 309 and pressure-plate-attachment-means 311. Tension-means 312 may be disposed between pressure-plate 307 and a portion of housing 215, such that tension-means 312 may push on both that portion of housing 215 and on pressure-plate 307. In some exemplary embodiments, tension-means 312 may comprise a tension-spring, see e.g. FIG. 4(a) and FIG. 4(b). When the fish bites the article (e.g. the baited hook) in communication with fishing-rod 900, a bite force may cause pressure on fishing-rod 900 such that the pressure overcomes the inherent tension of tension-means 312 and pressure-plate-contacts 309 may come into physical communication (contact) with circuit-contacts 306, activating circuit 303.

In some embodiments, each tension-means 312, e.g. the tension-spring, may include an inherent tension characteristic associated with that particular tension-means 312. When the angler may be fishing under circumstances wherein fishing-rod 900 may be moving from environmental sources other than fish bites (strikes) a tensions-means 312 with a stronger inherent tension may be utilized, so that false fish bite indications may be mitigated. Such environmental sources may include high winds and/or waves, e.g. when fishing in the surf, whether from a shore or a pier. Such environmental sources may also include swells when fishing from a boat. Likewise, when the angler may be fishing for larger fish and/or stronger fish, the angler may utilize fishing-rod-holder 100 with a stronger tension-means 312, to help mitigate against false fish bite indications. Thus a given tension-means 312 may be paired for particular fishing conditions. In some embodiments, the angler may be provided with one fishing-rod-holder 100, along with a plurality of different tension-means 312 for different fishing conditions. Whereas, in some embodiments, the angler may be provided with a plurality of fishing-rod-holders 100, wherein each fishing-rod-holder 100 selected from the plurality may include a tensions-means 312 with a different inherent tension.

In some exemplary embodiments, the bite-indication-means may comprise light-source 313 and/or sound-emitting-source 314. In some embodiments, the bite-indication-means may comprise light-source 313. In some embodiments, the bite-indication-means may comprise sound-emitting-source 314. It should be noted by one of ordinary skill in the art, that more than one light-source 313 may be used in various embodiments; and/or more than one sound-emitting-source 314 may be used in various embodiments. Light-source 313 when activated may shine light to an exterior of hollow-elongate-member 200. Such a light may be visible to the angler, particularly during nighttime angling. Sound-emitting-source 314 may produce an audible sound when activated.

In some exemplary embodiments the light-source 313 may emit light from 180 degree view around the exterior of hollow-elongate-member 200, particularly around housing 215, see e.g. FIG. 2(b).

In some exemplary embodiments light-source 313 may comprise one or more light-emitting-diodes (LEDs). In other embodiments, light-source 313 may comprise other light emitting technologies, such as incandescent light bulbs. In some exemplary embodiments, the sound-emitting-source 314 may comprise a buzzer. In some exemplary embodiments, the bite-indication-means may comprise both at least one LED and at least one buzzer.

Now turning to the FIG. 5 series of figures. The FIG. 5 series of figures may focus on the electrical aspects of fishing-rod-holder 100. FIG. 5(a) may depict a cutaway of housing 215 depicting substantially all of circuit 303 and the triggering-means housed within at least one compartment 216 of housing 215, shown from a front perspective view. (See FIG. 4(a) for at least one compartment 216.) FIG. 5(b) may depict an exemplary embodiment of a circuit diagram for circuit 303 of fishing-rod-holder 100. When circuit-contacts 306 and pressure-plate-contacts 309 may not be in physical communication (contact) with each other, then circuit 303 may be open and un-activated, such that the bite-indication-means may not be activated. When circuit-contacts 306 and pressure-plate-contacts 309 may be in physical communication (contact) with each other, then circuit 303 may be closed and activated, such that the bite-indication-means may be activated. Circuit 303 electrical power may be provided by power-source 304. Power-source 304 may comprise one or more batteries.

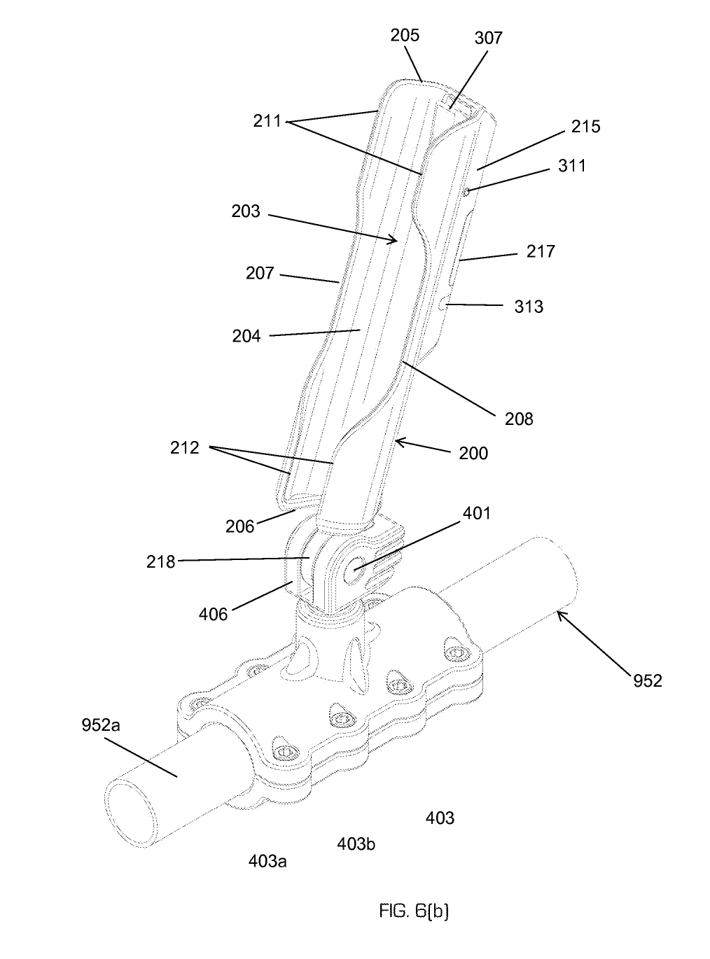

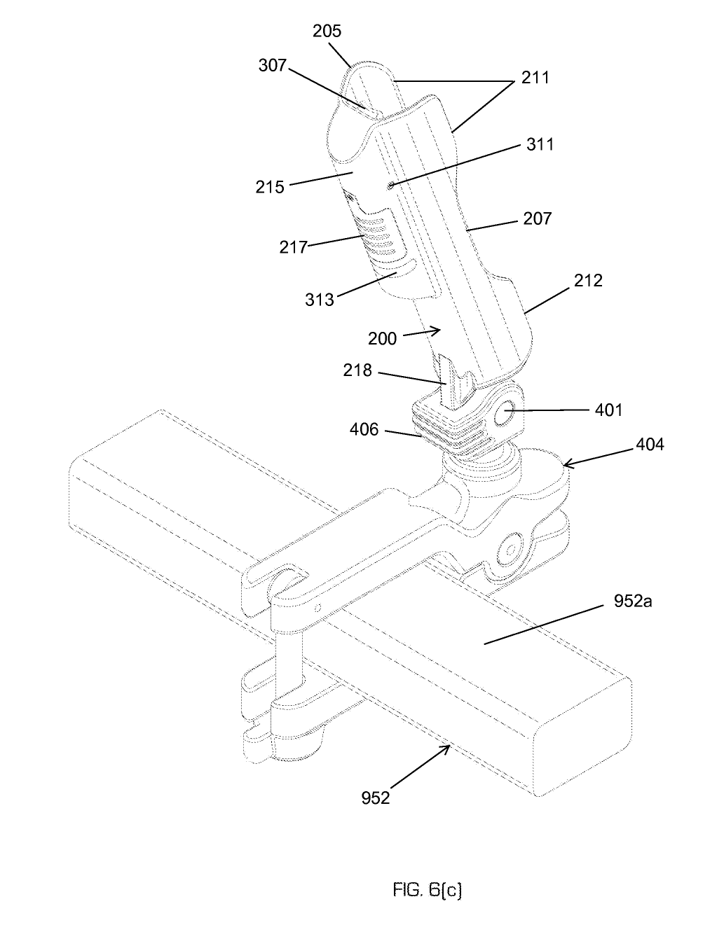

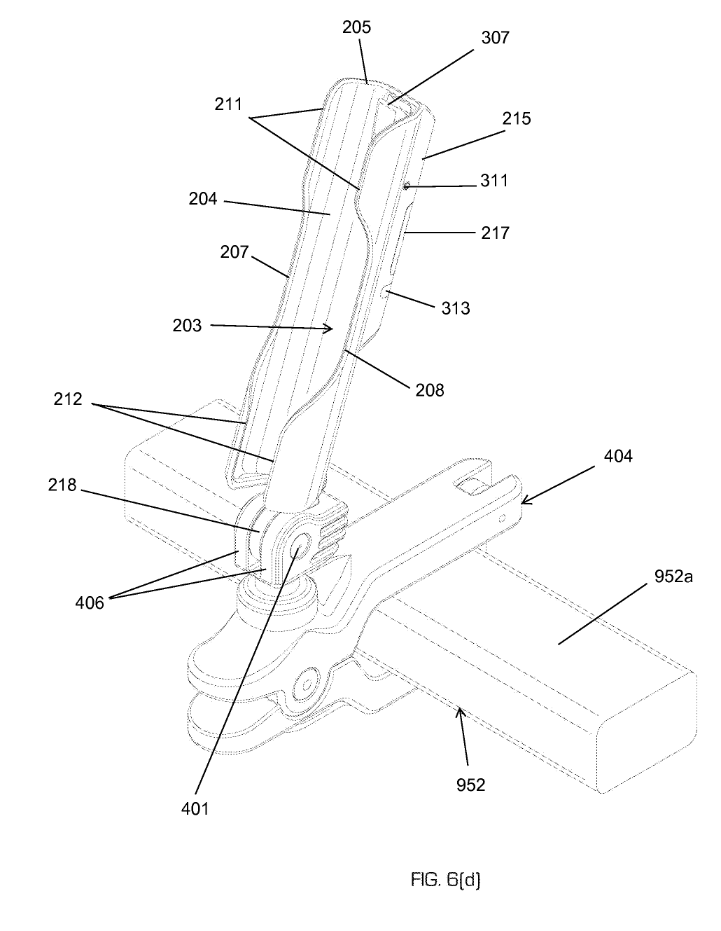

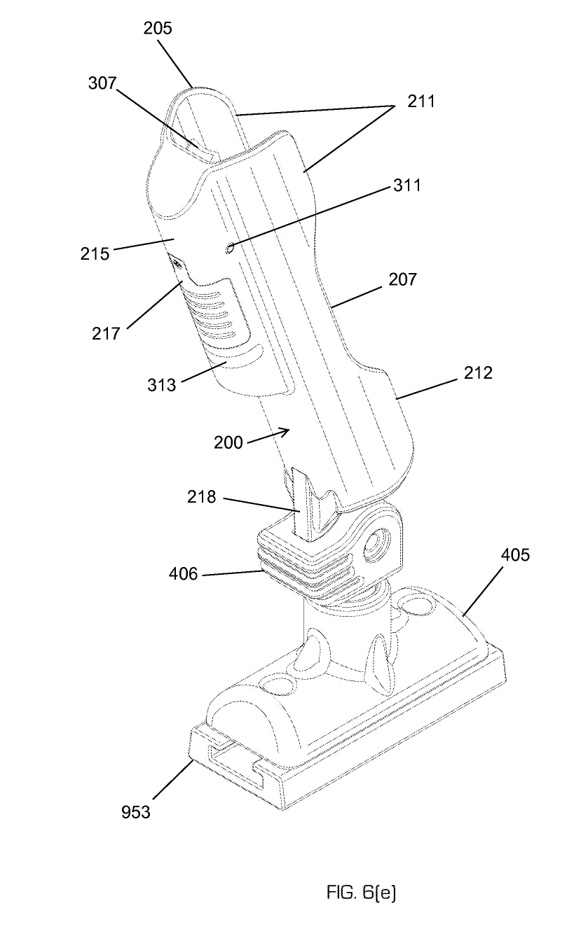

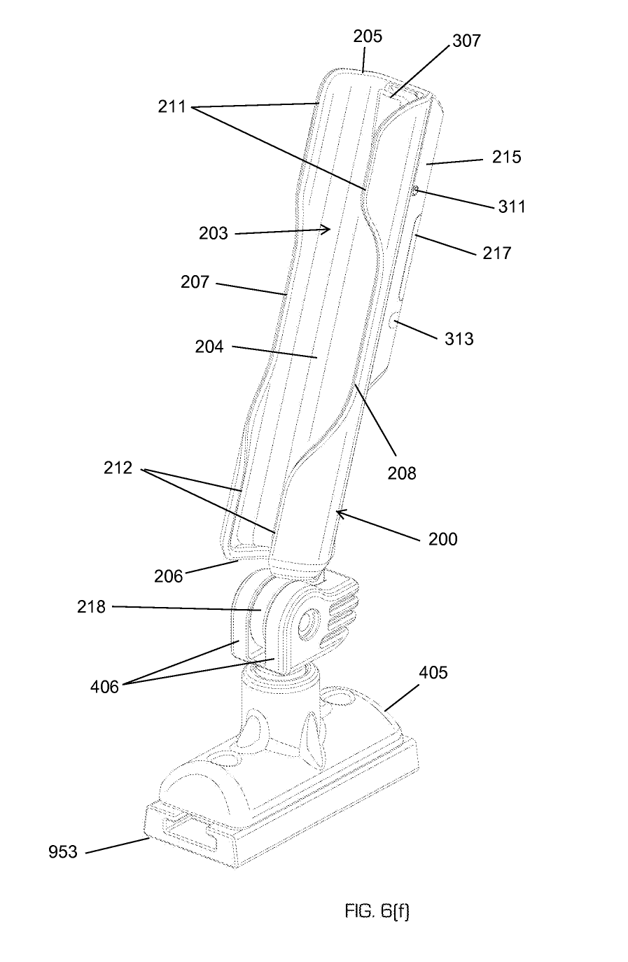

Now turning to the FIG. 6 series discussion. The FIG. 6 series of figures may focus on and depict various embodiments wherein the fishing-rod-holder may be used with different substrates. As noted above, fishing-rod-holder 100 may be used with earthen material 951 substrates. Other substrates may include tubular-members 952 and slide-tracks 953 (outer-slide 953). Tubular-members 952 may be hollow or solid. Tubular-members 952 may have ovoid cross-sections or polygonal cross-sections. Tubular-member 952 may be rails or railing components on piers, boats, ships, barges, and the like. Slide-rails 953 and the outer-slide 953 component of a slide-rail may be mounted on upper decks of kayaks and other water craft.

FIG. 6(a) may depict another exemplary embodiment of the fishing-rod-holder, wherein the substrate-engagement-means may comprise a tubing-clamp 403, shown from a front perspective view. FIG. 6(b) may depict the exemplary embodiment of FIG. 6(a), but shown from a back perspective view.

In such embodiments, the substrate-engagement-means may comprise tubing-clamp 403 and pivot-rod 401. Tubing-clamp 403 may comprise an upper-member 403a and a lower-member 403b. In this embodiment, the substrate may be tubular-member 952. Upper-member 403a and lower-member 403b may be configured to removably join together around tubular-member 952, such that an inside-surface of both upper-member 403a and lower-member 403b may circumscribe an outer-surface 952a of tubular-member 952, and such that a longitude of tubing-clamp 403 may be substantially parallel with a longitude of tubular-member 952. Upper-member 403a and lower-member 403b may be removably joined to each other by a coupling-means. For example, and without limiting the scope of the present invention, as depicted in FIG. 6(a) and FIG. 6(b), such a coupling-means may comprise a plurality of screws and/or bolts passing through threaded holes in a periphery of tubular-clamp 403.

In some embodiments, tubing-clamp 403 may comprise a protrusion 406 with an at least one pivot-rod-receiving-hole located at protrusion 406. Pivot-rod 401 may pass through both hole 219 and the at least one pivot-rod-receiving-hole, such that tubing-clamp 403 may be pivotable with respect to hollow-elongate-member 200, and such that tubing-clamp 200 may be attached to anchor 218. In some embodiments, protrusion 406 may also comprise a bearing such that hollow-elongate-member 200 may be rotated with respect to tubing-clamp 403.

FIG. 6(c) may depict another exemplary embodiment of the fishing-rod-holder, wherein the substrate-engagement-means may comprise a removable-clamp 404, shown from a front perspective view. FIG. 6(d) may depict the exemplary embodiment of FIG. 6(c), but shown from a back perspective view.

In such embodiments, the substrate-engagement-means may comprises removable-clamp 404 and pivot-rod 401. In such embodiments, the substrate may be tubular-member 952. Removable-clamp 404 may be configured to clamp around tubular-member 952 such that the fishing-rod-holder may be removably secured to tubular-member 952. Removable-clamp 404 may comprise two clamping arms, disposed opposite of each other and in communication with each other via a pivot element. As shown in FIG. 6(c) and FIG. 6(d), removable-clamp 404 may also comprise a locking arm to lock each of the two clamping arms to each other.

Removable-clamp 404 may comprise protrusion 406 with an at least one pivot-rod-receiving-hole located at the protrusion 406. Pivot-rod 401 may pass through both hole 219 and the at least one pivot-rod-receiving-hole, such that removable-clamp 404 may be pivotable with respect to hollow-elongate-member 200, and such that removable-clamp 404 may be attached to anchor 218.

In some embodiments, protrusion 406 may also comprise a bearing such that hollow-elongate-member 200 may be rotated with respect to removable-clamp 404.

Removable-clamp 404 may be better suited to removably attaching to tubular-members 952 with polygonal cross-sections; whereas, tubing-clamp 403 may be better suited to removably attaching to tubular-member 952 with ovoid cross-sections.

FIG. 6(e) may depict another exemplary embodiment of the fishing-rod-holder, wherein the substrate-engagement-means may comprise an inner-slide 405, shown from a front perspective view. FIG. 6(f) may depict the exemplary embodiment of FIG. 6(e), but shown from a back perspective view.

In such embodiments, the substrate-engagement-means may comprise inner-slide 405 and pivot-rod 401. In such embodiments, the substrate may be slide-track 953 with outer-slide 953. Outer-slide 953 may be configured to removably accept inner-slide 405 via a complimentary groove and slide system. In some embodiments, inner-slide 405 and outer-slide 953 may each include a longitude wherein each longitude is substantially parallel with each other. In some embodiments, inner-slide 405 and outer-slide 953 may translate with respect to each other in a longitudinal direction of each slide.

Inner-slide 405 may comprise protrusion 406 with an at least one pivot-rod-receiving-hole located at protrusion 406. Pivot-rod 401 may pass through both hole 219 and the at least one pivot-rod-receiving-hole, such that inner-slide 405 may be pivotable with respect to hollow-elongate-member 200, and such that inner-slide 405 may be attached to anchor 218.

In some embodiments, outer-slide 953 may be mounted on the upper edge of a kayak deck, such that a longitude of outer-slide 953 may be substantially parallel with a longitude of the kayak. Thus inner-slide 405 embodiment may permit kayak fishing with use of the fishing-rod-holder.

In some embodiments, protrusion 406 may also comprise a bearing such that hollow-elongate-member 200 may be rotated with respect to inner-slide 405.

In some exemplary embodiments, pivot-rod 401 may be removable by the angler, such that different substrate-engagement-means (e.g. stake 402, tubing-clamp 403, removable-clamp 404, inner-slide 405, and the like) may be removably attached to anchor 218, allowing the angler to use the fishing-rod-holder in various fishing conditions, from shore fishing, pier fishing, barge fishing, boat fishing, kayak fishing, and the like. In other embodiments, the angler may have a plurality of different fishing-rod-holders, wherein each fishing-rod-holder selected from the plurality may comprise a different substrate-engagement-means (e.g. stake 402, tubing-clamp 403, removable-clamp 404, inner-slide 405, and the like).

In some exemplary embodiments, hollow-elongate-member 200 and the substrate-engagement-means (e.g. stake 402) may both be substantially constructed of one or more materials suitable for injection molding.

In some exemplary embodiments, hollow-elongate-member 200 and the substrate-engagement-means may both be substantially constructed of one or more materials selected from the group comprising: polyoxymethylene (POM, such as Delrin®, Celcon®, Ramtal®, Duracon®, Hostaform®, and the like), acrylonitrile-butadiene styrene (ABS), polyvinyl chloride (PVC), polycarbonate, nylon, polystyrene, polypropylene (PP), and polyethylene (PE, including HDPE), and the like.

Use of “substantially constructed of” may be used to emphasize that some components of hollow-elongate-member 200 and/or of the substrate-engagement-means may not be constructed of an injection molded material. For example, and without limiting the scope of the present invention, tension-means 312 may comprise a metal component (e.g. stainless steel). For example, and without limiting the scope of the present invention, pressure-plate-attachment-means 311 (e.g. the pin and hinge system) may comprise a metal component (e.g. a stainless steel pin).

Where it may be desirable to include additional structural strength and rigidity, e.g. in stake 402, additional ribbing geometry may be incorporated and/or the materials of constructions may include fillers, such as glass fibers.

Note with respect to materials of construction, it is not desired nor intended to thereby unnecessarily limit the present invention by reason of such restricted disclosure.

Having disclosed and discussed various embodiments, some exemplary, of the fishing-rod-holder with integral fish-bite-detector, this disclosure now turns to a system for removably holding fishing-rod 900, detecting one or more fish bites, and alerting the angler of such fish bites, without the angler having to hold fishing-rod 900 while fishing.

Such an exemplary system may comprise: fishing-rod 900, hollow-elongate-member 200, the fish-bite-detector, and the substrate-engagement-means. Fishing-rod 900 may comprise fishing-rod-handle 901, fishing-reel 903 removably attached to fishing-rod 900, and fishing-line 904 connected to fishing-reel 903 and to the article (e.g. the baited hook) deployed in a body of water. Fishing-reel 903 may be a spinning reel, a conventional reel (including bait caster, free spool, and star drag), a spincast reel (e.g. often used by novice anglers and children), or a fly reel. Hollow-elongate-member 200 may be as discussed above. The fish-bite-detector may be as discussed above. And the substrate-engagement means may be as discussed above.

In exemplary systems, when the substrate-engagement-means may be removably engaging the substrate (e.g. 951, 952, and/or 953) and fishing-rod-handle 901 may be removably inserted and removably held within receiving-cavity 203, the fish biting (striking) on the article that may be in communication with fishing-rod 900 may trigger the triggering-means, wherein the triggered triggering-means may close and activate circuit 303, such that the bite-indication-means may be electrically activated, wherein the angler may alerted to the fish bite by the electrically activated bite-indication-means, e.g. light-source 313 and/or sound-emitting-source 314.

A fishing-rod-holder with integral fish-bite-detector and a system for removably holding a fishing rod, detecting one or more fish bites, and alerting the angler of such fish bites have been described and disclosed. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit or scope of the present invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fishing-rod-holder with integral fish-bite-detector, wherein the fishing-rod-holder comprises:
a substantially hollow-elongate-member, wherein the hollow-elongate-member comprises an inside-diameter running substantially along an elongate-portion, wherein the inside-diameter and the elongate-portion are substantially perpendicular to each other, wherein the inside-diameter is greater than an outside-diameter of a fishing-rod-handle of a fishing-rod, wherein the inside-diameter and the elongate-portion bound a receiving-cavity, wherein the receiving-cavity is configured to removably hold the fishing-rod-handle;
the fish-bite-detector, wherein the fish-bite-detector is integral to the hollow-elongate-member, wherein the fish-bite-detector comprises a triggering-means and a bite-indication-means, wherein the triggering-means and the bite-indication-means are in communication with each other; and
a substrate-engagement-means, wherein the substrate-engagement-means is attached to the hollow-elongate-member, wherein the substrate-engagement-means is configured to removably engage a substrate such that the fishing-rod-holder is removably mounted to the substrate;
wherein when the substrate-engagement-means is removably engaging the substrate and the fishing-rod-handle is removably inserted and removably held within the receiving-cavity, a fish biting on an article that is in communication with the fishing-rod triggers the triggering-means, wherein the triggering-means activates the bite-indication-means, wherein an angler is alerted to the fish bite by the bite-indication-means.

2. The fishing-rod-holder according to claim 1, wherein the hollow-elongate-member comprises an interior-surface running along the inside-diameter and along the elongate-portion, wherein the interior-surface faces the fishing-rod-handle when the fishing-rod-handle is removably held within the receiving-cavity.

3. The fishing-rod-holder according to claim 2, wherein the hollow-elongate-member comprises two terminal ends disposed of each other, an insertion-end and a butt-end; wherein the insertion-end and the butt-end are separated by the elongate-portion, wherein the insertion-end is substantially open to permit removable insertion of the fishing-rod-handle, wherein the butt-end is configured to prevent the fishing-rod-handle from translating beyond the butt-end when the receiving-cavity is removably holding the fishing-rod-handle.

4. The fishing-rod-holder according to claim 3, wherein the hollow-elongate-member comprises an opening-edge, wherein the opening-edge is a single continuous edge of the hollow-elongate-member; wherein along the elongate-portion, the opening-edge comprises two opposing opening-edges, a first-edge-portion and a second-edge-portion, wherein the first-edge-portion is separated from the second-edge-portion by an edge-separation-distance, such the first-edge-portion and the second-edge-portion bound an elongate-opening, wherein the elongate-opening comprises a width of the edge-separation-distance and a length of the elongate-portion.

5. The fishing-rod-holder according to claim 4, wherein the hollow-elongate-member comprises at least one pair-of-wings, wherein each wing of the pair-of-wings partially extends from the opening-edge into the elongate-opening, such that each wing of the pair-of-wings is separated from each other by a wing-separation-distance, wherein the pair-of-wings are configured to partially circumscribe the outside-diameter of the fishing-rod-handle when the fishing-rod-handle is removably held within the receiving-cavity, such that the pair-of-wings prevents the fishing-rod-handle from slipping out of the elongate-opening.

6. The fishing-rod-holder according to claim 5, wherein the at least one pair-of-wings comprises a first-pair-of-wings and a second-pair-of-wings, such that the first-pair-of-wings is located closer to the insertion-end than to the butt-end and the second-pair-of-wings is located closer to the butt-end than to the insertion-end; wherein each first-wing of the first-pair-of-wings is separated from each other by a first-wing-separation-distance; wherein each second-wing of the second-pair-of-wings is separated from each other by a second-wing-separation-distance; wherein both the first-wing-separation-distance and the second-wing-separation-distance are each less than the edge-separation-distance.

7. The fishing-rod-holder according to claim 4, wherein the hollow-elongate-member comprises a housing, wherein the housing is disposed opposite of the elongate-opening, wherein the housing comprises at least one compartment, wherein the at least one compartment houses the fish-bite-detector, wherein a portion of the compartment is removably sealable by a door, wherein the portion is configured to removably hold a power-source, wherein the power-source provides electrical power to the fish-bite-detector.

8. The fishing-rod-holder according to claim 7, wherein the fish-bite-detector comprises a circuit, wherein the circuit is substantially located within the at least one compartment, wherein the circuit comprises the power-source, electrical-connections, and circuit-contacts, wherein the electrical-connections connect the power-source and the circuit-contacts, to the bite-indication-means, such that when the triggering-means is triggered, the circuit is electrically activated and electrical power flows to the bite-indication-means activating the bite-indication-means.

9. The fishing-rod-holder according to claim 8, wherein the triggering-means comprises:
a pressure-plate, wherein the pressure-plate comprises a rod-surface, wherein the rod-surface is configured to be in physical communication with the fishing-rod-handle when the fishing-rod-handle is removably held within the receiving-cavity, wherein the pressure-plate comprises pressure-plate-contacts disposed opposite of the rod-surface;
a pressure-plate-opening, wherein the pressure-plate-opening provides an opening through the interior-surface for the pressure-plate to partially extend into the receiving-cavity, wherein the pressure-plate-opening is disposed opposite the elongate-opening;
a pressure-plate-attachment-means, wherein the pressure-plate-attachment-means attaches one side of the pressure-plate to the housing, such that the pressure-plate pivots about that one side; and
a tension-means, wherein the tension-means pushes the pressure-plate against the fishing-rod-handle when the fishing-rod-handle is removably held within the receiving-cavity, such that the pressure-plate-contacts do not activate the circuit; wherein the tension-means is in physical contact with the pressure-plate disposed between the pressure-plate-contacts and the pressure-plate-attachment-means; and wherein the tension-means is disposed between the pressure-plate and a portion of the housing, such that the tension-means pushes on both that portion of the housing and on the pressure-plate;
wherein when the fish bites the article in communication with the fishing-rod, a bite force causes pressure on the fishing-rod such that the pressure overcomes tension of the tension-means and the pressure-plate-contacts come into physical communication with the circuit-contacts, activating the circuit.

10. The fishing-rod-holder according to claim 8, wherein the bite-indication-means comprises a light-source and/or a sound-emitting-source; wherein the light-source when activated shines light to an exterior of the hollow-elongate-member; wherein the sound-emitting-source produces an audible sound when activated.

11. The fishing-rod-holder according to claim 3, wherein the hollow-elongate-member comprises an anchor, wherein the anchor serves a point of attachment for the substrate-engagement-means to attach to the hollow-elongate-member, wherein the anchor is a flange, extending substantially longitudinally from and away from the butt-end, wherein the anchor comprises a hole passing through a region of the anchor, wherein the hole is configured to receive a pivot-rod of the substrate-engagement-means, wherein the pivot-rod passes through the hole.

12. The fishing-rod-holder according to claim 11, wherein the substrate-engagement-means comprises a stake and the pivot-rod, wherein the stake is a rigid member configured to be removably inserted into the substrate, wherein the substrate is an earthen material; wherein the stake comprises two terminal ends with an at least one pivot-rod-receiving-hole located at one of the two terminal ends, wherein the pivot-rod passes through both the hole and the at least one pivot-rod-receiving-hole, such that the stake is foldable with respect to the hollow-elongate-member, and such that the stake is attached to the anchor.

13. The fishing-rod-holder according to claim 12, wherein the stake comprises a platform, wherein the platform is configured to be stepped upon by an angler's foot or struck by a hammer, to assist driving the stake into earthen material; wherein the platform is substantially perpendicular with a longitude of the stake, wherein such a longitude runs from one terminal end to the other; and wherein a top surface of the platform comprises non-slippage raised geometry to assist in engagement of a sole of a shoe or boot.

14. The fishing-rod-holder according to claim 11, wherein the substrate-engagement-means comprises a tubing-clamp and the pivot-rod, wherein the tubing-clamp comprises an upper-member and a lower-member, wherein the substrate is a tubular-member, wherein the upper-member and the lower-member are configured to removably join together around the tubular-member, such that an inside-surface of both the upper-member and the lower-member circumscribes an outer-surface of the tubular-member, and such that a longitude of the tubing-clamp is substantially parallel with a longitude of the tubular-member; wherein the upper-member and the lower-member are removably joined to each other by a coupling-means; wherein the tubing-clamp comprises a protrusion with an at least one pivot-rod-receiving-hole located at the protrusion, wherein the pivot-rod passes through both the hole and the at least one pivot-rod-receiving-hole, such that the tubing-clamp is pivotable with respect to the hollow-elongate-member, and such that the tubing-clamp is attached to the anchor.

15. The fishing-rod-holder according to claim 11, wherein the substrate-engagement-means comprises a removable-clamp and the pivot-rod, wherein the substrate is a tubular-member, wherein the removable-clamp is configured to clamp around a tubular-member; wherein the removable-clamp comprises a protrusion with an at least one pivot-rod-receiving-hole located at the protrusion, wherein the pivot-rod passes through both the hole and the at least one pivot-rod-receiving-hole, such that the removable-clamp is pivotable with respect to the hollow-elongate-member, and such that the removable-clamp is attached to the anchor.

16. The fishing-rod-holder according to claim 11, wherein the substrate-engagement-means comprise an inner-slide and the pivot-rod, wherein the substrate is a slide-track with an outer-slide configured to removably accept the inner-slide; wherein the inner-slide comprises a protrusion with an at least one pivot-rod-receiving-hole located at the protrusion, wherein the pivot-rod passes through both the hole and the at least one pivot-rod-receiving-hole, such that the inner-slide is pivotable with respect to the hollow-elongate-member, and such that the inner-slide is attached to the anchor.

17. The fishing-rod-holder according to claim 1, wherein the hollow-elongate-member and the substrate-engagement-means are both substantially constructed of one or more materials selected from the group consisting of polyoxymethylene, acrylonitrile-butadiene styrene, polyvinyl chloride, polycarbonate, nylon, polystyrene, polypropylene, and polyethylene.

18. A system for removably holding a fishing-rod, detecting a fish bite, and alerting an angler of the fish bite, wherein the system comprises:
the fishing-rod, wherein the fishing-rod comprises a fishing-rod-handle, a fishing-reel removably attached to the fishing-rod, and fishing-line connected to the fishing-reel and to an article deployed in a body of water;
a substantially hollow-elongate-member, wherein the hollow-elongate-member comprises an inside-diameter running substantially along an elongate-portion, wherein the inside-diameter and the elongate-portion are substantially perpendicular to each other, wherein the inside-diameter is greater than an outside-diameter of the fishing-rod-handle, wherein the inside-diameter and the elongate-portion bound a receiving-cavity, wherein the receiving-cavity is configured to removably hold the fishing-rod-handle;
a fish-bite-detector, wherein the fish-bite-detector is integral to the hollow-elongate-member, wherein the fish-bite-detector comprises a triggering-means, a bite-indication-means, and a circuit, wherein the triggering-means and the bite-indication-means are in communication with each other via the circuit; and
a substrate-engagement-means, wherein the substrate-engagement-means is attached to the hollow-elongate-member, wherein the substrate-engagement-means is configured to removably engage a substrate such that the fishing-rod-holder is removably mounted to the substrate; wherein the substrate is an earthen material, a tubular-member, or an outer-slide;
wherein when the substrate-engagement-means is removably engaging the substrate and the fishing-rod-handle is removably inserted and removably held within the receiving-cavity, a fish biting on the article that is in communication with the fishing-rod triggers the triggering-means, wherein the triggered triggering-means closes and activates the circuit, such that the bite-indication-means is electrically activated, wherein the angler is alerted to the fish bite by the electrically activated bite-indication-means.
